(19) United States
(12) Patent Application Publication
(10) Pub. No.: US 2020/0048382 A1
(43) Pub. Date: Feb. 13, 2020

(54) Mixed Catalyst Systems and Methods of Using the Same

(71) Applicant: ExxonMobil Chemical Patents Inc., Baytown, TX (US)

(72) Inventors: Matthew W. Holtcamp, Huffman, TX (US); Crisita Carmen H. Atienza, Houston, TX (US); Charles J. Harlan, Houston, TX (US); Xuan Ye, Houston, TX (US); Matthew S. Bedoya, Humble, TX (US); David F. Sanders, Beaumont, TX (US); David A. Cano, Houston, TX (US); Subramaniam Kuppuswamy, Mont Belvieu, TX (US); Michelle E. Titone, Houston, TX (US); Ching-Tai Lue, Sugarland, TX (US); Laughlin G. McCullough, League City, TX (US); Rohan A. Hule, Houston, TX (US)

(21) Appl. No.: 16/339,935

(22) PCT Filed: Oct. 4, 2017
(86) PCT No.: PCT/US2017/055159

§ 371 Date: Apr. 5, 2019

Related U.S. Application Data
(60) Provisional application No. 62/410,159, filed on Oct. 19, 2016.

(51) Int. Cl. C08F 210/16

(52) U.S. Cl. CPC C08F 210/16

(57) ABSTRACT

Disclosed herein is a catalyst system including a first catalyst compound represented by Formula (I):

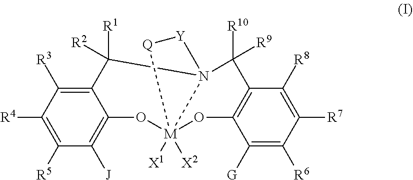

and a second catalyst compound that is a bridged or unbridged metallocene. M is a group 4 metal. X¹ and X² are independently a univalent C1-C20 hydrocarbyl, C1-C20 substituted hydrocarbyl, a heteroatom or a heteroatom-containing group, or X¹ and X² join together to form a C4-C62 cyclic or polycyclic ring structure. R¹, R², R³, R⁴, R⁵, R⁶, R⁷, R⁸, R⁹, and R¹⁰ is independently hydrogen, C1-C40 hydrocarbyl, C1-C40 substituted hydrocarbyl, a heteroatom or a heteroatom-containing group, or two or more of R¹, R², R³, R⁴, R⁵, R⁶, R⁷, R⁸, R⁹, or R¹⁰ are joined together to form a C4-C62 cyclic or polycyclic ring structure, or a combination thereof. Q is a neutral donor group. Methods of polymerizing with the catalyst system to produce polyolefin polymers are also disclosed.

### CROSS REFERENCE TO RELATED APPLICATIONS

This application claims priority to and the benefit of U.S. Ser. No. 62/410,159, filed Oct. 19, 2016, and is incorporated herein by reference in its entirety.

### FIELD

The present disclosure relates to bis(phenolate) and metallocene mixed catalyst systems and uses thereof.

### BACKGROUND

Polyolefins are widely used commercially because of their robust physical properties. For example, various types of polyethylenes, including high density, low density, and linear low density polyethylenes, are some of the most commercially useful. Polyolefins are typically prepared with a catalyst that polymerizes olefin monomers.

Low density polyethylene is generally prepared at high pressure using free radical initiators or in gas phase processes using Ziegler-Natta or vanadium catalysts. Low density polyethylene typically has a density at about 0.916 g/cm³. Typical low density polyethylene produced using free radical initiators is known in the industry as “LDPE”. LDPE is also known as “branched” or “heterogeneously branched” polyethylene because of the relatively large number of long chain branches extending from the main polymer backbone. Polyethylene with a similar density that does not contain branching is known as “linear low density polyethylene” (“LLDPE”) and is typically produced with conventional Ziegler-Natta catalysts or with metallocene catalysts. “Linear” means that the polyethylene has few, if any, long chain branches and typically has a g′ᵥᵢₛ value of 0.97 or above, such as 0.98 or above. Polyethylenes having still greater density are the high density polyethylenes (“HDPEs”), e.g., polyethylenes having densities greater than 0.940 g/cm³ and are generally prepared with Ziegler-Natta or chrome catalysts. Very low density polyethylenes (“VLDPEs”) can be produced by a number of different processes yielding polyethylenes typically having a density 0.890 to 0.915 g/cm³.

Copolymers of polyolefins, such as polyethylene, have a comonomer, such as hexene, incorporated into the polyethylene backbone. These copolymers provide varying physical properties compared to polyethylene alone and are typically produced in a low pressure reactor, utilizing, for example, solution, slurry, or gas phase polymerization processes. Polymerization may take place in the presence of catalyst systems such as those employing a Ziegler-Natta catalyst, a chromium based catalyst, or a metallocene catalyst.

A copolymer composition, such as a resin, has a composition distribution, which refers to the distribution of comonomer that forms short chain branches along the copolymer backbone. When the amount of short chain branches varies among the copolymer molecules, the composition is said to have a “broad” composition distribution. When the amount of comonomer per 1000 carbons is similar among the copolymer molecules of different chain lengths, the composition distribution is said to be “narrow”.

The composition distribution influences the properties of a copolymer composition, for example, stiffness, toughness, environmental stress crack resistance, and heat sealing, among other properties. The composition distribution of a polyolefin composition may be readily measured by, for example, Temperature Rising Elution Fractionation (TREF) or Crystallization Analysis Fractionation (CRYSTAF).

A composition distribution of a copolymer composition is influenced by the identity of the catalyst used to form the polyolefins of the composition. Ziegler-Natta catalysts and chromium based catalysts produce compositions with broad composition distributions (BCD), whereas metallocene catalysts typically produce compositions with narrow composition distributions (NCD).

Furthermore, polyolefins, such as polyethylenes, which have high molecular weight, generally have desirable mechanical properties over their lower molecular weight counterparts. However, high molecular weight polyolefins can be difficult to process and can be costly to produce. Polyolefin compositions having a bimodal molecular weight distribution are desirable because they can combine the advantageous mechanical properties of a high molecular weight (“HMW”) fraction of the composition with the improved processing properties of a low molecular weight (“LMW”) fraction of the composition. As used herein, “high molecular weight” is defined as a number average molecular weight (Mn) value of 150,000 g/mol or more. “Low molecular weight” is defined as an Mn value of less than 150,000 g/mol.

For example, useful bimodal polyolefin compositions include a first polyolefin having low molecular weight and high comonomer content (i.e., comonomer incorporated into the polyolefin backbone) while a second polyolefin has a high molecular weight and low comonomer content. As used herein, “low comonomer content” is defined as a polyolefin having 6 wt % or less of comonomer based upon the total weight of the polyolefin. The high molecular weight fraction produced by the second catalyst compound may have a high comonomer content. As used herein, “high comonomer content” is defined as a polyolefin having greater than 6 wt % of comonomer based upon the total weight of the polyolefin.

There are several methods for producing bimodal or broad molecular weight distribution polyolefins, e.g., melt blending, reactors in series or parallel configuration, or single reactor with bimetallic catalysts. However, these methods, such as melt blending, suffer from the disadvantages brought by the need for complete homogenization of polyolefin compositions and high cost.

Furthermore, synthesizing these bimodal polyolefin compositions in a mixed catalyst system would involve a first catalyst to catalyze the polymerization of, for example, ethylene under substantially similar conditions as that of a second catalyst while not interfering with the catalysis of polymerization of the second catalyst. For example, in a polymerization process, the degree of comonomer incorporation ability is often represented by the mole ratio of comonomer concentration to ethylene concentration involved in the polymerization medium to achieve a certain polymer density or average comonomer content. In a gas phase polymerization process the degree of comonomer incorporation ability would be derived from the concentrations of comonomer and monomer in the gas phase. In a slurry phase polymerization process this would be derived from the concentrations of comonomer and monomer in the liquid diluent phase. In a homogeneous solution phase polymerization process this would be derived from the concentrations of comonomer and monomer in the solution phase. For mixed catalyst systems having two metallocene catalysts, the comonomer to monomer mole ratio for the low comonomer incorporating catalyst to make a 0.920 g/cc density polymer is typically greater than twice the mole ratio of the high comonomer incorporating catalyst. Furthermore, mixed catalyst systems of only metallocene catalysts tend to produce compositions having two polymers with each polymer typically having substantially the same (typically low) molecular weight, albeit different comonomer content. Furthermore, the two different metallocene catalysts may interfere with the polymerization catalysis of each other, resulting in reduced catalytic activity, reduced molecular weight polyolefins, and reduced comonomer incorporation.

There exists a need for catalyst systems that provide polyolefin compositions having novel combinations of comonomer content fractions and molecular weights. There is further a need for novel catalyst systems where a first catalyst does not inhibit the polymerization catalysis of a second catalyst or vice versa.

### SUMMARY

In class of embodiments, the invention provides for a catalyst system comprising a first catalyst compound represented by Formula (I):

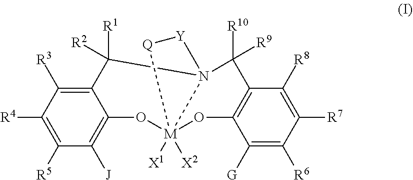

and a second catalyst compound that is a bridged or unbridged metallocene. M is a group 4 metal. X¹ and X² are independently a univalent C1-C20 hydrocarbyl, C1-C20 substituted hydrocarbyl, a heteroatom or a heteroatom-containing group, or X¹ and X² join together to form a C4-C62 cyclic or polycyclic ring structure. R¹, R², R³, R⁴, R⁵, R⁶, R⁷, R⁸, R⁹, and R¹⁰ is independently hydrogen, C1-C40 hydrocarbyl, C1-C40 substituted hydrocarbyl, a heteroatom or a heteroatom-containing group, or two or more of R¹, R², R³, R⁴, R⁵, R⁶, R⁷, R⁸, R⁹, or R¹⁰ are joined together to form a C4-C62 cyclic or polycyclic ring structure, or a combination thereof. Q is a neutral donor group. J is heterocycle, or a substituted or unsubstituted C7-C60 fused polycyclic group, where at least one ring is aromatic and where at least one ring, which may or may not be aromatic, has at least five ring atoms. G is as defined for J or may be hydrogen, C2-C60 hydrocarbyl, C1-C60 substituted hydrocarbyl, or may independently form a C4-C60 cyclic or polycyclic ring structure with R⁶, R⁷, or R⁸ or a combination thereof. Y is divalent C1-C20 hydrocarbyl or divalent C1-C20 substituted hydrocarbyl or (-Q*-Y—) together form a heterocycle.

In another class of embodiments, the invention provides for a method for producing a polyolefin composition comprising contacting one or more olefins with a catalyst system comprising: (a) the catalyst compound represented by Formula (I) and a bridged or unbridged metallocene catalyst compound.

### BRIEF DESCRIPTION OF THE FIGURES

FIG. 1 is a 4D GPC spectrum of a polyethylene resin formed from Catalyst System 1.

FIG. 2 is a GPC spectrum of a polyethylene resin formed from Catalyst System 4.

FIG. 3 is a GPC spectrum of a polyethylene resin formed from Catalyst System 6.

FIG. 4 is a TREF graph for Supported Catalyst System 2.

### DETAILED DESCRIPTION

For the purposes of the present disclosure, the numbering scheme for the Periodic Table Groups is used as described in CHEMICAL AND ENGINEERING NEWS, 63(5), pg. 27 (1985). Therefore, a “group 4 metal” is an element from group 4 of the Periodic Table, e.g., Hf, Ti, or Zr.

“Catalyst productivity” is a measure of how many grams of polymer (P) are produced using a polymerization catalyst comprising W g of catalyst (cat), over a period of time of T hours; and may be expressed by the following formula: P/(T×W) and expressed in units of gPgcat⁻¹ hr⁻¹. Conversion is the amount of monomer that is converted to polymer product, and is reported as mol % and is calculated based on the polymer yield (weight) and the amount of monomer fed into the reactor. Catalyst activity is a measure of how active the catalyst is and is reported as the mass of product polymer (P) produced per mass of supported catalyst (cat) (gP/g supported cat). In an at least one embodiment, the activity of the catalyst is at least 800 gpolymer/gsupported catalyst/hour, such as about 1,000 or more gpolymer/gsupported catalyst/hour, such as about 2,000 or more gpolymer/gsupported catalyst/hour, such as about 3,000 or more gpolymer/gsupported catalyst/hour, such as about 4,000 or more gpolymer/gsupported catalyst/hour, such as about 5,000 or more gpolymer/gsupported catalyst/hour.

An “olefin,” alternatively referred to as “alkene,” is a linear, branched, or cyclic compound of carbon and hydrogen having at least one double bond. For the purposes of the present disclosure, ethylene shall be considered an α-olefin. When a polymer or copolymer is referred to as comprising an olefin, the olefin present in such polymer or copolymer is the polymerized form of the olefin. For example, when a copolymer is said to have an ethylene content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” as used to refer to mer units indicates that the mer units differ from each other by at least one atom or are different isomerically. Accordingly, the definition of “copolymer,” as used herein, includes terpolymers and the like. An oligomer is typically a polymer having a low molecular weight, such an Mn of less than 25,000 g/mol, or less than 2,500 g/mol, or a low number of mer units, such as 75 mer units or less or 50 mer units or less. An “ethylene polymer” or “ethylene copolymer” is a polymer or copolymer comprising at least 50 mole % ethylene derived units, a “propylene polymer” or “propylene copolymer” is a polymer or copolymer comprising at least 50 mole % propylene derived units, and so on.

A “catalyst system” is a combination of at least one catalyst compound represented by Formula (I) and a second system component, such as a second catalyst compound and/or activator. The catalyst system may have at least one activator, at least one support material, and/or at least one co-activator. When catalyst systems are described as comprising neutral stable forms of the components, it is well understood by one of ordinary skill in the art, that the ionic form of the component is the form that reacts with the monomers to produce polymers. For the purposes of the present disclosure, “catalyst system” includes both neutral and ionic forms of the components of a catalyst system.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol.

In the present disclosure, the catalyst may be described as a catalyst precursor, a pre-catalyst compound, catalyst compound or a transition metal compound, and these terms are used interchangeably. An “anionic ligand” is a negatively charged ligand which donates one or more pairs of electrons to a metal ion. A “neutral donor ligand” is a neutrally charged ligand which donates one or more pairs of electrons to a metal ion.

For purposes of the present disclosure in relation to catalyst compounds, the term “substituted” means that a hydrogen group has been replaced with a hydrocarbyl group, a heteroatom, or a heteroatom containing group. For example, methylcyclopentadiene (MeCp) is a Cp group substituted with a methyl group, ethyl alcohol is an ethyl group substituted with an —OH group.

For purposes of the present disclosure, “alkoxides” include those where the alkyl group is a C1 to C10 hydrocarbyl. The alkyl group may be straight chain, branched, or cyclic. The alkyl group may be saturated or unsaturated. In at least one embodiment, the alkyl group may comprise at least one aromatic group. The term “alkoxy” or “alkoxide” preferably means an alkyl ether or aryl ether radical wherein the term alkyl is a C1 to C10 alkyl. Examples of suitable alkyl ether radicals include, but are not limited to, methoxy, ethoxy, n-propoxy, iso-propoxy, n-butoxy, iso-butoxy, sec-butoxy, tert-butoxy, phenoxyl, and the like.

The present disclosure describes transition metal complexes. The term complex is used to describe molecules in which an ancillary ligand is coordinated to a central transition metal atom. The ligand is stably bonded to the transition metal so as to maintain its influence during use of the catalyst, such as polymerization. The ligand may be coordinated to the transition metal by covalent bond and/or electron donation coordination or intermediate bonds. The transition metal complexes are generally subjected to activation to perform their polymerization function using an activator which is believed to create a cation as a result of the removal of an anionic group, often referred to as a leaving group, from the transition metal.

When used the present disclosure, the following abbreviations mean: dme is 1,2-dimethoxyethane, Me is methyl, Ph is phenyl, Et is ethyl, Pr is propyl, iPr is isopropyl, n-Pr is normal propyl, cPr is cyclopropyl, Bu is butyl, iBu is isobutyl, tBu is tertiary butyl, p-tBu is para-tertiary butyl, nBu is normal butyl, sBu is sec-butyl, TMS is trimethylsilyl, TIBAL is triisobutylaluminum, TNOAL is tri(n-octyl)aluminum, MAO is methylalumoxane, sMAO is supported methylalumoxane, p-Me is para-methyl, Bn is benzyl (i.e., CH₂Ph), THF (also referred to as thf) is tetrahydrofuran, RT is room temperature (and is 23° C. unless otherwise indicated), tol is toluene, EtOAc is ethyl acetate, and Cy is cyclohexyl.

The terms “hydrocarbyl radical,” “hydrocarbyl,” “hydrocarbyl group,” “alkyl radical,” and “alkyl” are used interchangeably throughout this disclosure. Likewise, the terms “group”, “radical”, and “substituent” are also used interchangeably in this disclosure. For purposes of this disclosure, “hydrocarbyl radical” is defined to be C1-C100 radicals, that may be linear, branched, or cyclic, and when cyclic, aromatic or non-aromatic. Examples of such radicals include, but are not limited to, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted hydrocarbyl radicals are radicals in which at least one hydrogen atom of the hydrocarbyl radical has been substituted with at least a non-hydrogen group, such as halogen (such as Br, Cl, F or I) or at least one functional group such as NR*₂, OR*, SeR*, TeR*, PR*₂, AsR*₂, SbR*₂, SR*, BR*₂, SiR*₃, GeR*₃, SnR*₃, PbR*₃, and the like, or where at least one heteroatom has been inserted within a hydrocarbyl ring.

The term “alkenyl” means a straight-chain, branched-chain, or cyclic hydrocarbon radical having one or more carbon-carbon double bonds. These alkenyl radicals may be substituted. Examples of suitable alkenyl radicals include, but are not limited to, ethenyl, propenyl, allyl, 1,4-butadienyl cyclopropenyl, cyclobutenyl, cyclopentenyl, cyclohexenyl, cycloctenyl and the like including their substituted analogues.

The term “aryl” or “aryl group” means a carbon-containing aromatic ring and the substituted variants thereof, including but not limited to, phenyl, 2-methyl-phenyl, xylyl, 4-bromo-xylyl. Likewise, heteroaryl means an aryl group where a ring carbon atom (or two or three ring carbon atoms) has been replaced with a heteroatom, preferably N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise, the term aromatic also refers to substituted aromatics.

Where isomers of a named alkyl, alkenyl, alkoxide, or aryl group exist (e.g., n-butyl, iso-butyl, sec-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tert-butyl).

The term “ring atom” means an atom that is part of a cyclic ring structure. By this definition, a benzyl group has six ring atoms and tetrahydrofuran has 5 ring atoms. A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

“Complex” as used herein, is also often referred to as catalyst precursor, precatalyst, catalyst, catalyst compound, transition metal compound, or transition metal complex. These terms are used interchangeably. Activator and cocatalyst are also used interchangeably.

A scavenger is a compound that may be added to a catalyst system to facilitate polymerization by scavenging impurities. Some scavengers may also act as activators and may be referred to as co-activators. A co-activator, that is not a scavenger, may also be used in conjunction with an activator in order to form an active catalyst system. In at least one embodiment, a co-activator can be pre-mixed with the transition metal compound to form an alkylated transition metal compound.

In the present disclosure, a catalyst may be described as a catalyst precursor, a pre-catalyst compound, catalyst compound or a transition metal compound, and these terms are used interchangeably. A polymerization catalyst system is a catalyst system that can polymerize monomers into polymer.

The term “continuous” means a system that operates without interruption or cessation for a period of time. For example, a continuous process to produce a polymer would be one where the reactants are continually introduced into one or more reactors and polymer product is continually withdrawn.

A “solution polymerization” means a polymerization process in which the polymerization is conducted in a liquid polymerization medium, such as an inert solvent or monomer(s) or their blends. A solution polymerization is typically homogeneous. A homogeneous polymerization is one where the polymer product is dissolved in the polymerization medium. Such systems are preferably not turbid as described in J. Vladimir Oliveira, C. Dariva and J. C. Pinto, Ind. Eng. Chem. Res. (2000), 29, 4627.

A bulk polymerization means a polymerization process in which the monomers and/or comonomers being polymerized are used as a solvent or diluent using little or no inert solvent or diluent. A small fraction of inert solvent might be used as a carrier for catalyst and scavenger. A bulk polymerization system contains less than about 25 wt % of inert solvent or diluent, such as less than about 10 wt %, such as less than about 1 wt %, such as 0 wt %.

### Catalyst Compounds

The present disclosure provides novel bis(phenolate) and metallocene mixed catalyst systems and uses thereof.

Methods of the present disclosure provide polymers with bimodal composition distributions and enhanced properties in a single reactor utilizing a catalyst system including both a catalyst compound providing low comonomer content/high molecular weight polyolefin and a second catalyst compound providing high comonomer content/low molecular weight polyolefin. A larger difference in the comonomer incorporation ability of the high comonomer incorporator and the low comonomer incorporator can provide a more broadly separated bimodal polymer composition which can provide polyolefin compositions having unique properties.

In at least one embodiment, the present disclosure provides a catalyst system comprising a first catalyst compound (a bis(phenolate) catalyst) represented by Formula (I):

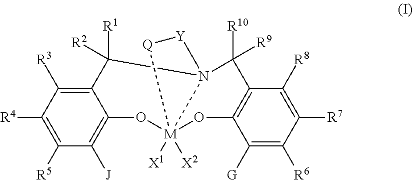

and a second catalyst compound that is a bridged or unbridged metallocene. M is a group 4 metal. X¹ and X² are independently a univalent C1-C20 hydrocarbyl, C1-C20 substituted hydrocarbyl, a heteroatom or a heteroatom-containing group, or X¹ and X² join together to form a C4-C62 cyclic or polycyclic ring structure. R¹, R², R³, R⁴, R⁵, R⁶, R⁷, R⁸, R⁹, and R¹⁰ is independently hydrogen, C1-C40 hydrocarbyl, C1-C40 substituted hydrocarbyl, a heteroatom or a heteroatom-containing group, or two or more of R¹, R², R³, R⁴, R⁵, R⁶, R⁷, R⁸, R⁹, or R¹⁰ are joined together to form a C4-C62 cyclic or polycyclic ring structure, or a combination thereof. Q is a neutral donor group. J is heterocycle, a substituted or unsubstituted C7-C60 fused polycyclic group, where at least one ring is aromatic and where at least one ring, which may or may not be aromatic, has at least five ring atoms. G is as defined for J or may be hydrogen, C2-C60 hydrocarbyl, C1-C60 substituted hydrocarbyl, or may independently form a C4-C60 cyclic or polycyclic ring structure with R⁶, R⁷, or R⁸ or a combination thereof. Y is divalent C1-C20 hydrocarbyl or divalent C1-C20 substituted hydrocarbyl or (-Q*-Y—) together form a heterocycle. Heterocycle may be aromatic and/or may have multiple fused rings.

In at least one embodiment, the first catalyst compound represented by Formula (I) is:

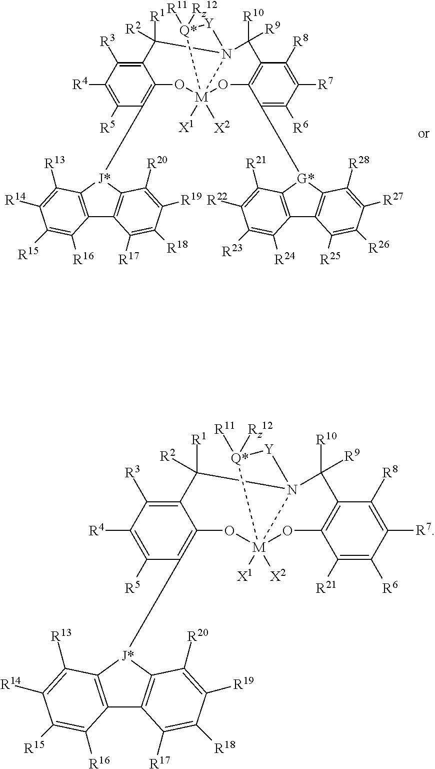

M is Hf, Zr, or Ti. X¹, X², R¹, R², R³, R⁴, R⁵, R⁶, R⁷, R⁸, R⁹, R¹⁰, and Y are as defined for Formula (I). R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, and R²⁸ is independently a hydrogen, C1-C40 hydrocarbyl, C1-C40 substituted hydrocarbyl, a functional group comprising elements from Groups 13 to 17, or two or more of R¹, R², R³, R⁴, R⁵, R⁶, R⁷, R, R⁹, R¹⁰ R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, and R²⁸ may independently join together to form a C4-C62 cyclic or polycyclic ring structure, or a combination thereof. R¹¹ and R¹² may join together to form a five- to eight-membered heterocycle. Q* is a group 15 or 16 atom. z is 0 or 1. J* is CR″ or N, and G* is CR″ or N, where R″ is C1-C20 hydrocarbyl or carbonyl-containing C1-C20 hydrocarbyl. z=0 if Q* is a group 16 atom, and z=1 if Q* is a group 15 atom.

In at least one embodiment, the first catalyst compound represented by Formula (I) is:

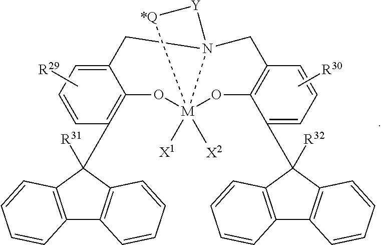

Y is a divalent C1-C3 hydrocarbyl. Q* is NR₂, OR, SR, PR₂, where R is as defined for R¹ represented by Formula (I). M is Zr, Hf, or Ti. X¹ and X² is independently as defined for Formula (I). R²⁹ and R³⁰ is independently C1-C40 hydrocarbyl. R³¹ and R³² is independently linear C1-C20 hydrocarbyl, benzyl, or tolyl.

The first catalyst compound represented by Formula (I) may be one or more of:

| | Structure |
|---|---|
| 1 | 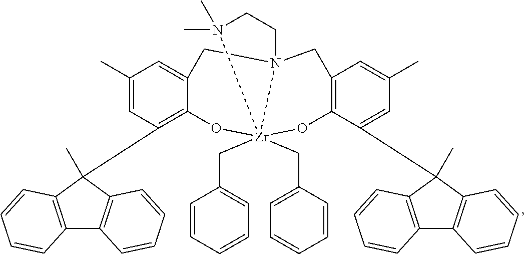 |
| 2 | 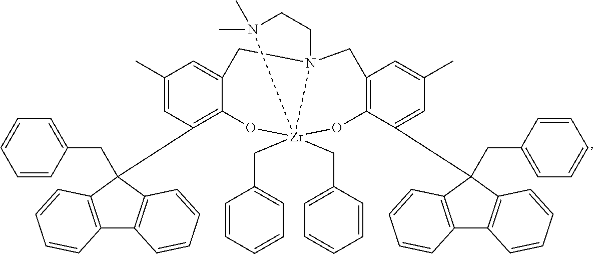 |
| 3 | 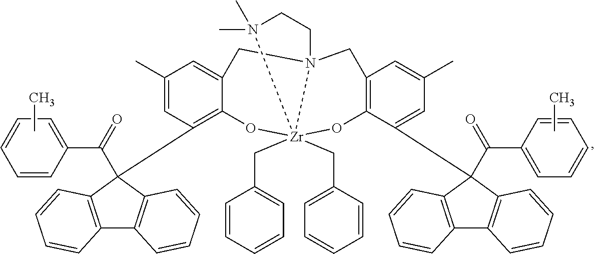 |
| 4 | 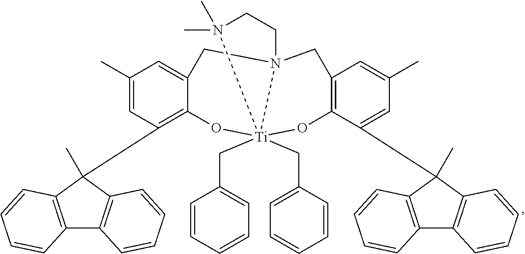 |
| 5 | 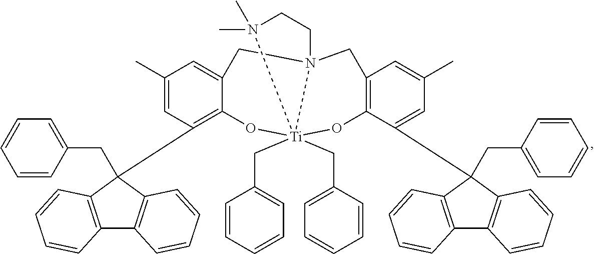 |
| 6 | 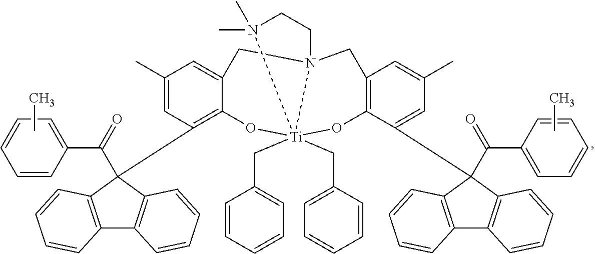 |
| 7 | 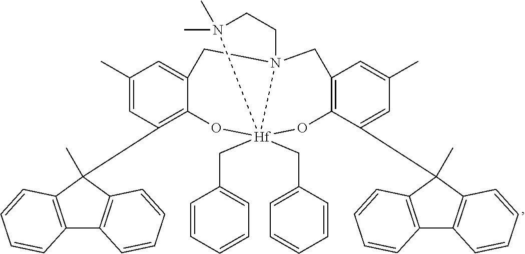 |
| 8 | 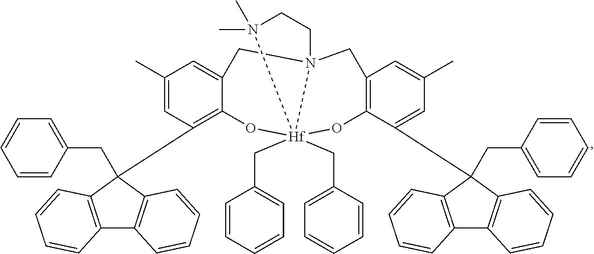 |
| 9 | 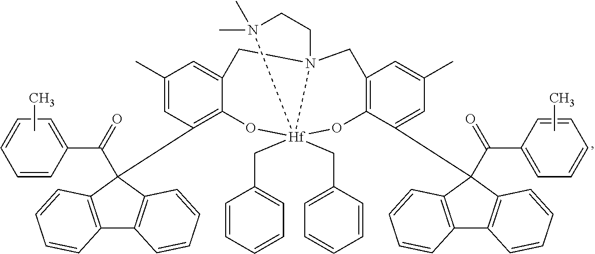 |
| 10 | 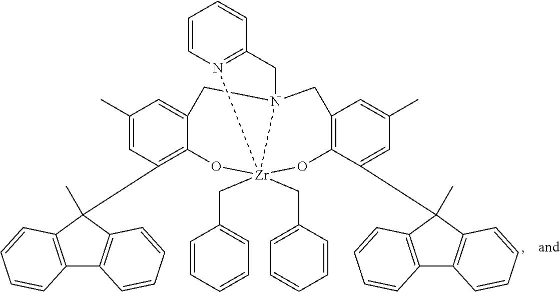 |
| 11 | 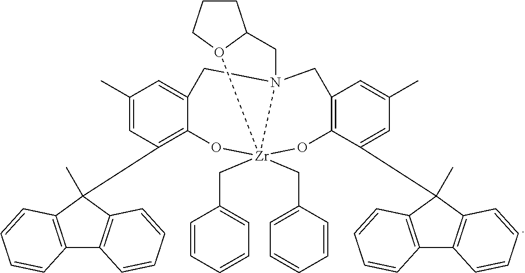 |

Metallocene catalyst compounds as used herein include metallocenes comprising Group 3 to Group 12 metal complexes, preferably, Group 4 to Group 6 metal complexes, for example, Group 4 metal complexes. The metallocene catalyst compound of catalyst systems of the present disclosure may be an unbridged metallocene catalyst compound represented by the formula: Cp^{A}Cp^{B}M′X′ₙ. Each Cp^{A} and Cp^{B} is independently selected from cyclopentadienyl ligands and ligands isolobal to cyclopentadienyl, one or both Cp^{A} and Cp^{B} may contain heteroatoms, and one or both Cp^{A} and Cp^{B} may be substituted by one or more R″ groups. M′ is selected from Groups 3 through 12 atoms and lanthanide Group atoms. X′ is an anionic leaving group. n is 0 or an integer from 1 to 4. R″ is selected from alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, ether, and thioether.

In at least one embodiment, each Cp^{A} and Cp^{B} is independently selected from cyclopentadienyl, indenyl, fluorenyl, cyclopentaphenanthreneyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, and hydrogenated versions thereof.

The metallocene catalyst compound may be a bridged metallocene catalyst compound represented by the formula: Cp^{A}(A)Cp^{B}M′X′ₙ. Each Cp^{A} and Cp^{B} is independently selected from cyclopentadienyl ligands and ligands isolobal to cyclopentadienyl. One or both Cp^{A} and Cp^{B} may contain heteroatoms, and one or both Cp^{A} and Cp^{B} may be substituted by one or more R″ groups. M′ is selected from Groups 3 through 12 atoms and lanthanide Group atoms. X′ is an anionic leaving group. n is 0 or an integer from 1 to 4. (A) is selected from divalent alkyl, divalent lower alkyl, divalent substituted alkyl, divalent heteroalkyl, divalent alkenyl, divalent lower alkenyl, divalent substituted alkenyl, divalent heteroalkenyl, divalent alkynyl, divalent lower alkynyl, divalent substituted alkynyl, divalent heteroalkynyl, divalent alkoxy, divalent lower alkoxy, divalent aryloxy, divalent alkylthio, divalent lower alkylthio, divalent arylthio, divalent aryl, divalent substituted aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocycle, divalent heteroaryl, a divalent heteroatom-containing group, divalent hydrocarbyl, divalent lower hydrocarbyl, divalent substituted hydrocarbyl, divalent heterohydrocarbyl, divalent silyl, divalent boryl, divalent phosphino, divalent phosphine, divalent amino, divalent amine, divalent ether, divalent thioether. R″ is selected from alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, ether, and thioether.

In at least one embodiment, each of Cp^{A} and Cp^{B} is independently selected from cyclopentadienyl, n-propylcyclopentadienyl, indenyl, pentamethylcyclopentadienyl, tetramethylcyclopentadienyl, and n-butylcyclopentadienyl.

(A) may be O, S, NR′, or SiR′₂, where each R′ is independently hydrogen or C1-C20 hydrocarbyl.

In another embodiment, the metallocene catalyst compound is represented by the formula:

T_{y}CpₘMGₙX_{q},

where Cp is independently a substituted or unsubstituted cyclopentadienyl ligand or substituted or unsubstituted ligand isolobal to cyclopentadienyl. M is a group 4 transition metal. G is a heteroatom group represented by the formula JR*z where J is N, P, O or S, and R* is a linear, branched, or cyclic C1-C20 hydrocarbyl. z is 1 or 2. T is a bridging group. y is 0 or 1. X is a leaving group. m=1, n=1, 2 or 3, q=0, 1, 2 or 3, and the sum of m+n+q is equal to the oxidation state of the transition metal.

In at least one embodiment, J is N, and R* is methyl, ethyl, propyl, butyl, pentyl, hexyl, heptyl, octyl, nonyl, cyclooctyl, cyclododecyl, decyl, undecyl, dodecyl, adamantyl or an isomer thereof.

The metallocene catalyst compound may be selected from:
dimethylsilyl (tetramethylcyclopentadienyl)(cyclododecylamido)titanium dimethyl;
dimethylsilyl (tetramethylcyclopentadienyl)(cyclododecylamido)titanium dichloride;
dimethylsilyl (tetramethylcyclopentadienyl)(t-butylamido)titanium dimethyl;
dimethylsilyl (tetramethylcyclopentadienyl)(t-butylamido)titanium dichloride;
μ-(CH₃)₂Si(cyclopentadienyl)(1-adamantylamido)M(R)₂;
μ-(CH₃)₂Si(3-tertbutylcyclopentadienyl)(1-adamantylamido)M(R)₂;
μ-(CH₃)₂(tetramethylcyclopentadienyl)(1-adamantylamido)M(R)₂;
μ-(CH₃)₂Si(tetramethylcyclopentadienyl)(1-adamantylamido)M(R)₂;
μ-(CH₃)₂C (tetramethylcyclopentadienyl)(1-adamantylamido)M(R)₂;
μ-(CH₃)₂Si(tetramethylcyclopentadienyl)(1-tertbutylamido)M(R)₂;
μ-(CH₃)₂Si(fluorenyl)(1-tertbutylamido)M(R)₂;
μ-(CH₃)₂Si(tetramethylcyclopentadienyl)(1-cyclododecylamido)M(R)₂;
μ-(C₆H₅)₂C (tetramethylcyclopentadienyl)(1-cyclododecylamido)M(R)₂;
μ-(CH₃)₂Si(η⁵-2,6,6-trimethyl-1,5,6,7-tetrahydro-s-indacen-1-yl)(tertbutylamido)M(R)₂;
where M is selected from Ti, Zr, and Hf and R is selected from halogen or C1 to C5 alkyl.

In another embodiment, the metallocene catalyst compound is one or more of:

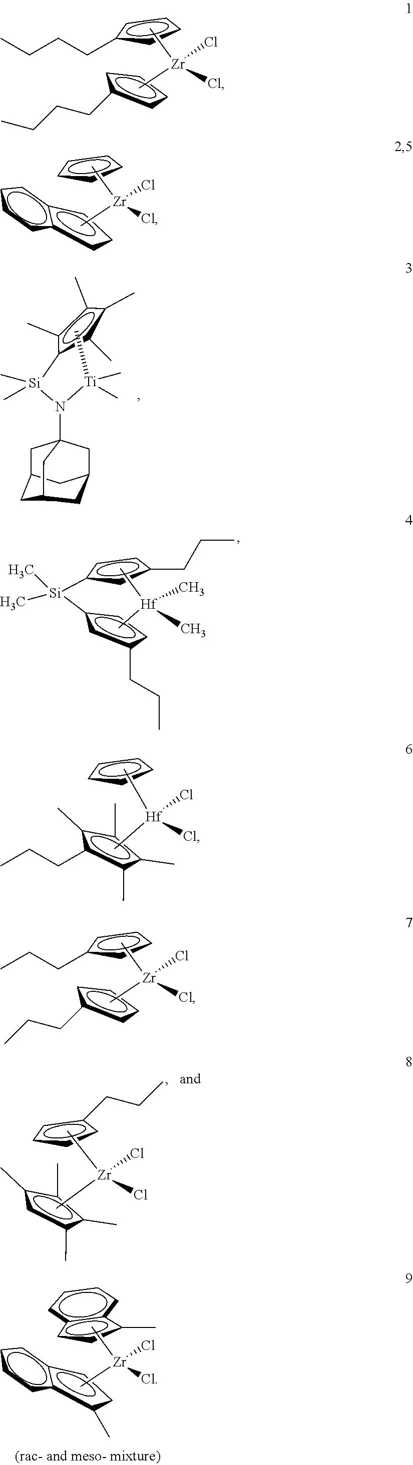

Catalyst systems of the present disclosure may comprise an activator and a support material, as described in more detail below.

For purposes of the present disclosure one catalyst compound is considered different from another if they differ by at least one atom. For example “bisindenyl zirconium dichloride” is different from (indenyl)(2-methylindenyl) zirconium dichloride” which is different from “(indenyl)(2-methylindenyl) hafnium dichloride.” Catalyst compounds that differ only by isomer are considered the same for purposes if this disclosure, e.g., rac-dimethylsilylbis(2-methyl 4-phenyl)hafnium dimethyl is considered to be the same as meso-dimethylsilylbis(2-methyl 4-phenyl)hafnium dimethyl.

In at least one embodiment, two or more different catalyst compounds are present in the catalyst system used herein. In at least one embodiment, two or more different catalyst compounds are present in the reaction zone where the process(es) described herein occur. When two transition metal catalysts are used in one reactor as a mixed catalyst system, the two transition metal compounds are preferably chosen such that the two are compatible. Any suitable screening method, such as by ¹H or ¹³C NMR, can be used to determine which transition metal compounds are compatible. It is preferable to use the same activator for the transition metal compounds, however, two different activators, such as a non-coordinating anion activator and an alumoxane, can be used in combination. If one or more transition metal compounds contain an X₁ or X₂ ligand which is not a hydride, hydrocarbyl, or substituted hydrocarbyl, then the alumoxane should be contacted with the transition metal compounds prior to addition of the non-coordinating anion activator.

The catalyst compound represented by Formula (I) and the second catalyst compound may be used in any ratio (A:B). The catalyst compound represented by Formula (I) may be (A) if the second catalyst compound is (B). Alternatively, the catalyst compound represented by Formula (I) may be (B) if the second catalyst compound is (A). Preferred molar ratios of (A) transition metal compound to (B) transition metal compound fall within the range of (A:B) about 1:1000 to about 1000:1, such as between about 1:100 and about 500:1, such as between about 1:10 and about 200:1, such as between about 1:1 and about 100:1, and alternatively 1:1 to 75:1, and alternatively 5:1 to 50:1. The particular ratio chosen will depend on the exact pre-catalysts chosen, the method of activation, and the end product desired. In a particular embodiment, when using the two catalyst compounds, where both are activated with the same activator, useful mole percents, based upon the molecular weight of the catalyst compounds, are between about 10 to about 99.9% of (A) to about 0.1 and about 90% of (B), such as between about 25 and about 99% (A) to about 0.5 and about 50% (B), such as between about 50 and about 99% (A) to about 1 and about 25% (B), such as between about 75 and about 99% (A) to about 1 to about 10% (B).

### Methods to Prepare the Catalyst Compounds

Bis(phenolate) catalyst compounds: In an embodiment of the invention (as shown in Scheme 1), the bis(phenolate) transition metal compounds may be prepared by two general synthetic routes. In an embodiment of the invention, the amine bis(phenolate) ligands may be prepared by a one-step Mannich reaction from the parent phenol (Reaction A) or by a nucleophilic substitution reaction of the methylbromide derivative of the phenol (Reaction B). The ligand is then typically reacted with the metal tetra-alkyl compound, e.g., tetrabenzyl, to yield the metal dibenzyl complex of the ligand (Reaction C).

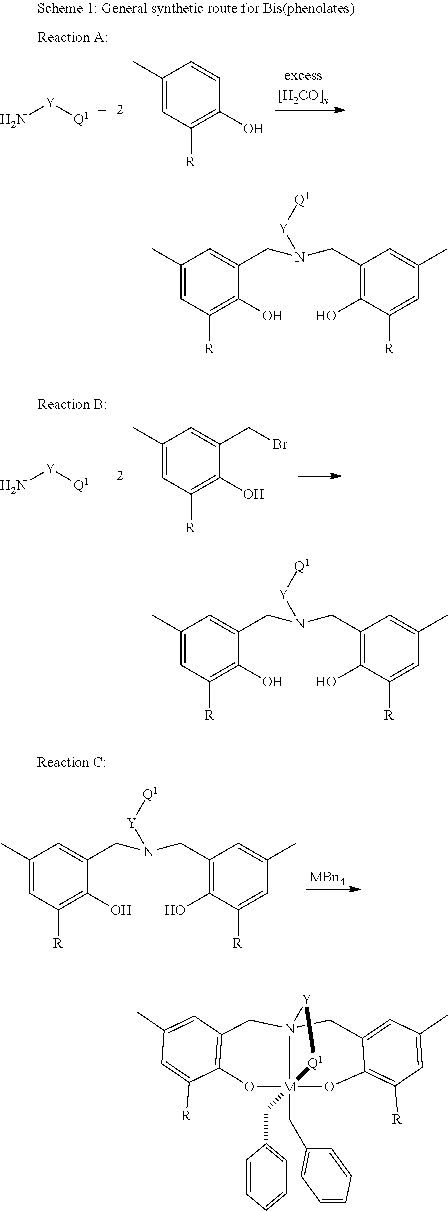

M, Y, and Q¹ are as defined for M, Y, and Q above, [H₂CO]ₓ is paraformaldehyde, Bn is benzyl, and each R is, independently, as defined for G or J above, provided that at least one R is as defined for J.

### Hafnocene Catalyst Compounds

Silyl-bridged cyclopentadienyl ligands R′₂Si(n-PrCpH)₂ (where R′=Me, Ph) have been synthesized quantitatively by direct salt metathesis reaction between R′₂SiCl₂ and two equivalents of lithium-n-propyl-cyclopentadienide in tetrahydrofuran solvent at ambient temperature (Scheme 2). The synthesized neutral ligands are conveniently deprotonated with n-butyl lithium at −25° C. The absence of cyclopentadienyl protons between 6=3.2 ppm and 6=3.6 ppm in ¹H NMR spectra further supports the lithium salt formation. The salt elimination route has been adopted to synthesis corresponding hafnocene dichloride by an equimolar ratio of the above lithium salt of cyclopentadienide ligands with hafnium tetrachloride. Further, treatment of silyl-bridged cyclopentadienide hafnium dichloride with two equivalents of methyl magnesium bromide under milder reaction conditions afforded a pale yellow Me₂Si(n-proylCp)₂HfMe₂ and Ph₂Si(n-proylCp)₂HfMe₂ metallocene catalyst compounds in good yield. Catalyst precursors and hafnocene catalyst compounds structures were confirmed by ¹H NMR spectroscopy.

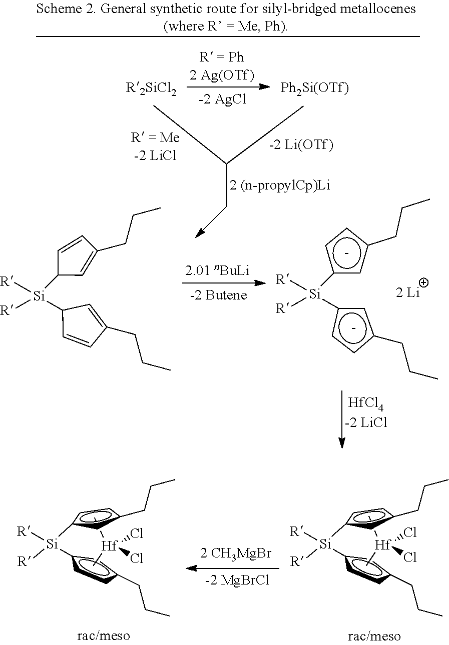

### Activators

The supported catalyst systems may be formed by combining the above catalysts with activators in any manner known from the literature including by supporting them for use in slurry or gas phase polymerization. Activators are defined to be any compound which can activate any one of the catalyst compounds described above by converting the neutral metal compound to a catalytically active metal compound cation. Non-limiting activators, for example, include alumoxanes, aluminum alkyls, ionizing activators, which may be neutral or ionic, and conventional-type cocatalysts. Preferred activators typically include alumoxane compounds, modified alumoxane compounds, and ionizing anion precursor compounds that abstract a reactive, σ-bound, metal ligand making the metal compound cationic and providing a charge-balancing noncoordinating or weakly coordinating anion.

### Alumoxane Activators

Alumoxane activators are utilized as activators in the catalyst systems described herein. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane.

Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584).

When the activator is an alumoxane (modified or unmodified), some embodiments select the maximum amount of activator typically at up to a 5000-fold molar excess Al/M over the catalyst compound (per metal catalytic site). The minimum activator-to-catalyst-compound is a 1:1 molar ratio. Alternate preferred ranges include from 1:1 to 500:1, alternately from 1:1 to 200:1, alternately from 1:1 to 100:1, or alternately from 1:1 to 50:1.

In an alternate embodiment, little or no alumoxane is used in the polymerization processes described herein. Preferably, alumoxane is present at zero mole %, alternately the alumoxane is present at a molar ratio of aluminum to catalyst compound transition metal less than 500:1, preferably less than 300:1, preferably less than 100:1, preferably less than 1:1.

### Ionizing/Non Coordinating Anion Activators

The term “non-coordinating anion” (NCA) means an anion which either does not coordinate to a cation or which is only weakly coordinated to a cation thereby remaining sufficiently labile to be displaced by a neutral Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with this invention are those that are compatible, stabilize the transition metal cation in the sense of balancing its ionic charge at +1, and yet retain sufficient lability to permit displacement during polymerization. Ionizing activators useful herein typically comprise an NCA, particularly a compatible NCA.

It is within the scope of this invention to use an ionizing activator, neutral or ionic, such as tri (n-butyl) ammonium tetrakis (pentafluorophenyl) borate, a tris perfluorophenyl boron metalloid precursor or a tris perfluoronaphthyl boron metalloid precursor, polyhalogenated heteroborane anions (WO 98/43983), boric acid (U.S. Pat. No. 5,942,459), or combination thereof. It is also within the scope of this invention to use neutral or ionic activators alone or in combination with alumoxane or modified alumoxane activators. For descriptions of useful activators please see U.S. Pat. Nos. 8,658,556 and 6,211,105.

Preferred activators include N,N-dimethylanilinium tetrakis(perfluoronaphthyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Me₃NH⁺][B(C₆F₅)₄⁻]; 1-(4-(tris(pentafluorophenyl)borate)-2,3,5,6-tetrafluorophenyl)pyrrolidinium; and tetrakis(pentafluorophenyl)borate, 4-(tris(pentafluorophenyl)borate)-2,3,5,6-tetrafluoropyridine.

In a preferred embodiment, the activator comprises a triaryl carbonium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate).

In another embodiment, the activator comprises one or more of trialkylammonium tetrakis(pentafluorophenyl)borate, N,N-dialkylanilinium tetrakis(pentafluorophenyl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis(perfluoronaphthyl)borate, N,N-dialkylanilinium tetrakis(perfluoronaphthyl)borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, di-(i-propyl)ammonium tetrakis(pentafluorophenyl)borate, (where alkyl is methyl, ethyl, propyl, n-butyl, sec-butyl, or t-butyl).

The typical activator-to-catalyst ratio, e.g., all NCA activators-to-catalyst ratio is about a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 5:1.

### Optional Scavengers or Co-Activators

In addition to these activator compounds, catalyst systems of the present disclosure may include scavengers or co-activators. Scavengers or co-activators include aluminum alkyl or organoaluminum compounds, for example, trimethylaluminum, triethylaluminum, triisobutylaluminum, tri-n-hexylaluminum, tri-n-octylaluminum, and diethyl zinc.

### Optional Support Materials

In at least one embodiment, a catalyst system comprises an inert support material. The supported material may be a porous support material, for example, talc, and inorganic oxides. Other support materials include zeolites, clays, organoclays, or any other organic or inorganic support material and the like, or mixtures thereof.

In at least one embodiment, the support material is an inorganic oxide in a finely divided form. Suitable inorganic oxide materials for use in catalyst systems herein include Groups 2, 4, 13, and 14 metal oxides, such as silica, alumina, and mixtures thereof. Other inorganic oxides that may be employed either alone or in combination with the silica, or alumina are magnesia, titania, zirconia, and the like. Other suitable support materials, however, can be employed, for example, finely divided functionalized polyolefins, such as finely divided polyethylene. Particularly useful supports include magnesia, titania, zirconia, montmorillonite, phyllosilicate, zeolites, talc, clays, and the like. Also, combinations of these support materials may be used, for example, silica-chromium, silica-alumina, silica-titania, and the like. In at least one embodiment, the support material is selected from Al₂O₃, ZrO₂, SiO₂, SiO₂/Al₂O₂, or mixtures thereof. The support material may be fluorided.

As used herein, the phrases “fluorided support” and “fluorided support composition” mean a support, desirably particulate and porous, which has been treated with at least one inorganic fluorine containing compound. For example, the fluorided support composition can be a silicon dioxide support wherein a portion of the silica hydroxyl groups has been replaced with fluorine or fluorine containing compounds. Suitable fluorine containing compounds include, but are not limited to, inorganic fluorine containing compounds and/or organic fluorine containing compounds.

Fluorine compounds suitable for providing fluorine for the support may be organic or inorganic fluorine compounds and are desirably inorganic fluorine containing compounds. Such inorganic fluorine containing compounds may be any compound containing a fluorine atom as long as it does not contain a carbon atom. Particularly desirable are inorganic fluorine-containing compounds selected from NH₄BF₄, (NH₄)₂SiF₆, NH₄PF₆, NH₄F, (NH₄)₂TaF₇, NH₄NbF₄, (NH₄)₂GeF₆, (NH₄)₂SmF₆, (NH₄)₂TiF₆, (NH₄)₂ZrF₆, MoF₆, ReF₆, GaF₃, SO₂ClF, F₂, SiF₄, SF₆, ClF₃, ClF₅, BrFs, IF₇, NF₃, HF, BF₃, NHF₂, NH₄HF₂, and combinations thereof. In at least one embodiment, ammonium hexafluorosilicate and ammonium tetrafluoroborate are used.

It is preferred that the support material, most preferably an inorganic oxide, has a surface area between about 10 and about 700 m²/g, pore volume between about 0.1 and about 4.0 cc/g and average particle size between about 5 and about 500 m. In at least one embodiment, the surface area of the support material is between about 50 and about 500 m²/g, pore volume between about 0.5 and about 3.5 cc/g and average particle size between about 10 and about 200 μm. The surface area of the support material may be between about 100 and about 400 m²/g, pore volume between about 0.8 and about 3.0 cc/g and average particle size between about 5 and about 100 μm. The average pore size of the support material may be between about 10 and about 1000 Å, such as between about 50 and about 500 Å, such as between about 75 and about 350 Å. In at least one embodiment, the support material is a high surface area, amorphous silica (surface area=300 m²/gm; pore volume of 1.65 cm³/gm). Non-limiting example silicas are marketed under the tradenames of DAVISON 952 or DAVISON 955 by the Davison Chemical Division of W.R. Grace and Company. In other embodiments, DAVISON 948 is used.

The support material should be dry, that is, free of absorbed water. Drying of the support material can be effected by heating or calcining at between about 100° C. and about 1000° C., such as at least about 600° C. When the support material is silica, it is heated to at least 200° C., such as between about 200° C. and about 850° C., such as about 600° C.; and for a time between about 1 minute and about 100 hours, between about 12 hours and about 72 hours, or between about 24 hours and about 60 hours. The calcined support material should have at least some reactive hydroxyl (OH) groups to produce supported catalyst systems of the present disclosure. The calcined support material is then contacted with at least one polymerization catalyst system comprising, for example, at least one catalyst compound and an activator.

The support material, having reactive surface groups, typically hydroxyl groups, is slurried in a non-polar solvent and the resulting slurry is contacted with a solution of at least one catalyst compound, for example one or two catalyst compounds, and an activator. In at least one embodiment, the slurry of the support material is first contacted with the activator for a period of time between about 0.5 hours and about 24 hours, such as between about 2 hours and about 16 hours, or between about 4 hours and about 8 hours. The solution of the catalyst compound is then contacted with the isolated support/activator. In at least one embodiment, the supported catalyst system is generated in situ. In at least one embodiment, the slurry of the support material is first contacted with the catalyst compound for a period of time between about 0.5 hours and about 24 hours, such as between about 2 hours and about 16 hours, or between about 4 hours and about 8 hours. The slurry of the supported catalyst compound(s) is then contacted with the activator solution.

The mixture of the catalyst, activator and support may be heated to between about 0° C. and about 70° C., such as between about 23° C. and about 60° C., for example room temperature. Contact times may be between about 0.5 hours and about 24 hours, such as between about 2 hours and about 16 hours, or between about 4 hours and about 8 hours.

Suitable non-polar solvents are materials in which all of the reactants used herein, e.g., the activator, and the catalyst compound, are at least partially soluble and which are liquid at reaction temperatures. Non-limiting example non-polar solvents are alkanes, such as isopentane, hexane, n-heptane, octane, nonane, and decane, cycloalkanes, such as cyclohexane, aromatics, such as benzene, toluene, and ethylbenzene.

### Polymerization Processes

A catalyst compound represented by Formula (I) is compatible with metallocene catalyst compounds under polymerization conditions, such that one catalyst of the catalyst system does not interfere with the polymerization catalysis performed by the other catalyst of the catalyst system. The compatibility of a catalyst compound represented by Formula (I) provides catalyst systems and use of such catalyst systems where a second catalyst compound that can be selected from a variety of metallocenes provides polyolefin compositions with variable PDI in the formed polyolefin compositions, for example from high PDI to lower PDI with BCD compositions depending on the second catalyst compound. Furthermore, molecular weights of polyolefins of a polyolefin composition may be further controlled by the use of hydrogen gas flow in a polymerization reactor. A catalyst compound represented by Formula (I) reacts readily with hydrogen to terminate polymerization of a polyolefin thereby controlling the molecular weight.

In at least one embodiment of the present disclosure, a method includes polymerizing olefins to produce a polyolefin composition utilizing a catalyst system having a first catalyst represented by Formula (I) and a metallocene catalyst. The polyolefin composition may be a multi-modal polyolefin composition comprising ethylene and one or more comonomers and comprising a high molecular weight fraction comprising a comonomer content between about 1 wt % and about 10 wt %, such as between about 1 wt % and about 6 wt %, of the high molecular weight fraction. The polyolefin composition may be a multi-modal polyolefin composition comprising a high molecular weight fraction comprising a polydispersity index of between about 1 and about 5.

Polymerization may be conducted at a temperature of from about 0° C. to about 300° C., at a pressure in the range of from about 0.35 MPa to about 10 MPa, and/or at a time up to about 300 minutes.

Embodiments of the present disclosure include polymerization processes where monomer (such as ethylene or propylene), and optionally comonomer, are contacted with a catalyst system comprising at least one catalyst compound and an activator, as described above. The at least one catalyst compound and activator may be combined in any order, and are combined typically prior to contact with the monomer.

Monomers useful herein include substituted or unsubstituted C2 to C40 alpha olefins, preferably C2 to C20 alpha olefins, preferably C2 to C12 alpha olefins, preferably ethylene, propylene, butene, pentene, hexene, heptene, octene, nonene, decene, undecene, dodecene and isomers thereof. In a preferred embodiment, olefins include a monomer that is propylene and one or more optional comonomers comprising one or more ethylene or C4 to C40 olefin, preferably C4 to C20 olefin, or preferably C6 to C12 olefin. The C4 to C40 olefin monomers may be linear, branched, or cyclic. The C4 to C40 cyclic olefin may be strained or unstrained, monocyclic or polycyclic, and may include one or more heteroatoms and/or one or more functional groups. In another preferred embodiment, olefins include a monomer that is ethylene and an optional comonomer comprising one or more of C3 to C40 olefin, preferably C4 to C20 olefin, or preferably C6 to C12 olefin. The C3 to C40 olefin monomers may be linear, branched, or cyclic. The C3 to C40 cyclic olefins may be strained or unstrained, monocyclic or polycyclic, and may include heteroatoms and/or one or more functional groups.

Exemplary C2 to C40 olefin monomers and optional comonomers include ethylene, propylene, butene, pentene, hexene, heptene, octene, nonene, decene, undecene, dodecene, norbomene, norbomadiene, dicyclopentadiene, cyclopentene, cycloheptene, cyclooctene, cyclooctadiene, cyclododecene, 7-oxanorbomene, 7-oxanorbomadiene, substituted derivatives thereof, and isomers thereof, preferably hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbomene, norbomadiene, and substituted derivatives thereof, preferably norbomene, norbomadiene, and dicyclopentadiene.

In at least one embodiment, one or more dienes are present in a polymer produced herein at up to about 10 wt %, such as between about 0.00001 and about 1.0 wt %, such as between about 0.002 and about 0.5 wt %, such as between about 0.003 and about 0.2 wt %, based upon the total weight of the composition. In at least one embodiment, about 500 ppm or less of diene is added to the polymerization, such as about 400 ppm or less, such as about 300 ppm or less. In at least one embodiment, at least about 50 ppm of diene is added to the polymerization, or about 100 ppm or more, or 150 ppm or more.

Diolefin monomers include any hydrocarbon structure, preferably C4 to C30, having at least two unsaturated bonds, wherein at least two of the unsaturated bonds are readily incorporated into a polymer by either a stereospecific or a non-stereospecific catalyst(s). It is further preferred that the diolefin monomers be selected from alpha, omega-diene monomers (i.e., di-vinyl monomers). In at least one embodiment, the diolefin monomers are linear di-vinyl monomers, such as those containing from 4 to 30 carbon atoms. Non-limiting examples of dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Non-limiting example cyclic dienes include cyclopentadiene, vinylnorbomene, norbomadiene, ethylidene norbornene, divinylbenzene, dicyclopentadiene or higher ring containing diolefins with or without substituents at various ring positions.

In at least one embodiment, where butene is the comonomer, the butene source may be a mixed butene stream comprising various isomers of butene. The 1-butene monomers are expected to be preferentially consumed by the polymerization process as compared to other butene monomers. Use of such mixed butene streams will provide an economic benefit, as these mixed streams are often waste streams from refining processes, for example, C4 raffinate streams, and can therefore be substantially less expensive than pure 1-butene.

Polymerization processes of the present disclosure can be carried out in any suitable manner known in the art. Any suspension, homogeneous, bulk, solution, slurry, or gas phase polymerization process known in the art can be used. Such processes can be run in a batch, semi-batch, or continuous mode. Homogeneous polymerization processes and slurry processes are preferred. (A homogeneous polymerization process is defined to be a process where at least about 90 wt % of the product is soluble in the reaction media.) A bulk homogeneous process is particularly preferred. (A bulk process is defined to be a process where monomer concentration in all feeds to the reactor is 70 vol % or more.) Alternately, no solvent or diluent is present or added in the reaction medium, (except for the small amounts used as the carrier for the catalyst system or other additives, or amounts typically found with the monomer; e.g., propane in propylene). In another embodiment, the process is a slurry process. As used herein, the term “slurry polymerization process” means a polymerization process where a supported catalyst is used and monomers are polymerized on the supported catalyst particles. At least 95 wt % of polymer products derived from the supported catalyst are in granular form as solid particles (not dissolved in the diluent). Methods of the present disclosure may include introducing the first catalyst compound represented by Formula (I) into a reactor as a slurry.

Suitable diluents/solvents for polymerization include non-coordinating, inert liquids. Non-limiting examples include straight and branched-chain hydrocarbons, such as isobutane, butane, pentane, isopentane, hexane, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C4 to C10 alkanes, chlorobenzene, and aromatic and alkylsubstituted aromatic compounds, such as benzene, toluene, mesitylene, and xylene. Suitable solvents also include liquid olefins which may act as monomers or comonomers including, but not limited to, ethylene, propylene, 1-butene, 1-hexene, 1-pentene, 3-methyl-1-pentene, 4-methyl-1-pentene, 1-octene, 1-decene, and mixtures thereof. In a preferred embodiment, aliphatic hydrocarbon solvents are used as the solvent, such as isobutane, butane, pentane, isopentane, hexane, isohexane, heptane, octane, dodecane, or mixtures thereof; cyclic and alicyclic hydrocarbons, such as cyclohexane, cycloheptane, methylcyclohexane, methylcycloheptane, or mixtures thereof. In another embodiment, the solvent is not aromatic, and aromatics are present in the solvent at less than about 1 wt %, such as less than about 0.5 wt %, such as about 0 wt % based upon the weight of the solvents.

In at least one embodiment, the feed concentration of the monomers and comonomers for the polymerization is about 60 vol % solvent or less, preferably about 40 vol % or less, or about 20 vol % or less, based on the total volume of the feedstream. Preferably the polymerization is run in a bulk process.

Preferred polymerizations can be run at any temperature and/or pressure suitable to obtain the desired polyolefins. Typical temperatures and/or pressures include a temperature between about 0° C. and about 300° C., such as between about 20° C. and about 200° C., such as between about 35° C. and about 150° C., such as between about 40° C. and about 120° C., such as between about 45° C. and about 80° C.; and at a pressure between about 0.35 MPa and about 10 MPa, such as between about 0.45 MPa and about 6 MPa, or preferably between about 0.5 MPa and about 4 MPa.

In a typical polymerization, the run time of the reaction is up to about 300 minutes, such as between about 5 and about 250 minutes, such as between about 10 and about 120 minutes.

Hydrogen, may be added to a reactor for molecular weight control of polyolefins. In at least one embodiment, hydrogen is present in the polymerization reactor at a partial pressure of between about 0.001 and 50 psig (0.007 to 345 kPa), such as between about 0.01 and about 25 psig (0.07 to 172 kPa), such as between about 0.1 and 10 psig (0.7 to 70 kPa). In one embodiment, 600 ppm or less of hydrogen is added, or 500 ppm or less of hydrogen is added, or 400 ppm or less or 300 ppm or less. In other embodiments, at least 50 ppm of hydrogen is added, or 100 ppm or more, or 150 ppm or more.

In an alternate embodiment, the activity of the catalyst is at least about 50 g/mmol/hour, such as about 500 or more g/mmol/hour, such as about 5,000 or more g/mmol/hr, such as about 50,000 or more g/mmol/hr. In an alternate embodiment, the conversion of olefin monomer is at least about 10%, based upon polymer yield (weight) and the weight of the monomer entering the reaction zone, such as about 20% or more, such as about 30% or more, such as about 50% or more, such as about 80% or more.

In at least one embodiment, little or no alumoxane is used in the process to produce the polymers. Preferably, alumoxane is present at zero mol %. Alternatively, the alumoxane is present at a molar ratio of aluminum to transition metal of the catalyst represented by Formula (I) less than about 500:1, such as less than about 300:1, such as less than about 100:1, such as less than about 1:1.

In a preferred embodiment, little or no scavenger is used in the process to produce the polyolefin composition. Preferably, scavenger (such as tri alkyl aluminum) is present at zero mol %. Alternatively, the scavenger is present at a molar ratio of scavenger metal to transition metal of the catalyst represented by Formula (I) of less than about 100:1, such as less than about 50:1, such as less than about 15:1, such as less than about 10:1.

In a preferred embodiment, the polymerization: 1) is conducted at temperatures of 0 to 300° C. (preferably 25 to 150° C., preferably 40 to 120° C., preferably 45 to 80° C.); 2) is conducted at a pressure of atmospheric pressure to 10 MPa (preferably 0.35 to 10 MPa, preferably from 0.45 to 6 MPa, preferably from 0.5 to 4 MPa); 3) is conducted in an aliphatic hydrocarbon solvent (such as isobutane, butane, pentane, isopentane, hexanes, isohexane, heptane, octane, dodecane, and mixtures thereof; cyclic or alicyclic hydrocarbons, such as cyclohexane, cycloheptane, methylcyclohexane, methylcycloheptane, or mixtures thereof; preferably where aromatics are present in the solvent at less than 1 wt %, preferably less than 0.5 wt %, preferably at 0 wt % based upon the weight of the solvents); 4) wherein the catalyst system used in the polymerization comprises less than 0.5 mol % alumoxane, preferably 0 mol % alumoxane. Alternatively, the alumoxane is present at a molar ratio of aluminum to transition metal of the catalyst represented by Formula (I) less than 500:1, preferably less than 300:1, preferably less than 100:1, preferably less than 1:1; 5) the polymerization preferably occurs in one reaction zone; 6) the productivity of the catalyst compound is at least 80,000 g/mmol/hr (preferably at least 150,000 g/mmol/hr, preferably at least 200,000 g/mmol/hr, preferably at least 250,000 g/mmol/hr, preferably at least 300,000 g/mmol/hr); 7) optionally scavengers (such as trialkyl aluminum compounds) are absent (e.g., present at zero mol %. Alternatively, the scavenger is present at a molar ratio of scavenger metal to transition metal of less than 100:1, preferably less than 50:1, preferably less than 15:1, preferably less than 10:1); and 8) optionally hydrogen is present in the polymerization reactor at a partial pressure of 0.001 to 50 psig (0.007 to 345 kPa) (preferably from 0.01 to 25 psig (0.07 to 172 kPa), more preferably 0.1 to 10 psig (0.7 to 70 kPa)). In a preferred embodiment, the catalyst system used in the polymerization comprises no more than one catalyst compound. A “reaction zone”, also referred to as a “polymerization zone”, is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In a preferred embodiment, the polymerization occurs in one reaction zone.

Other additives may also be used in the polymerization, as desired, such as one or more scavengers, promoters, modifiers, chain transfer agents (such as diethyl zinc), reducing agents, oxidizing agents, hydrogen, aluminum alkyls, or silanes.

Chain transfer agents may be alkylalumoxanes, a compound represented by the formula AlR₃, ZnR2 (where each R is, independently, a C₁-C₈ aliphatic radical, preferably methyl, ethyl, propyl, butyl, penyl, hexyl, heptyl, octyl or an isomer thereof) or a combination thereof, such as diethyl zinc, methylalumoxane, trimethylaluminum, triisobutylaluminum, trioctylaluminum, or a combination thereof.

Gas phase polymerization: Generally, in a fluidized gas bed process used for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228; all of which are fully incorporated herein by reference.)

Slurry phase polymerization: A slurry polymerization process generally operates between 1 to about 50 atmosphere pressure range (15 psi to 735 psi, 103 kPa to 5068 kPa) or even greater and temperatures in the range of 0° C. to about 120° C. In a slurry polymerization, a suspension of solid, particulate polymer is formed in a liquid polymerization diluent medium to which monomer and comonomers, along with catalysts, are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, preferably a branched alkane. The medium employed should be liquid under the conditions of polymerization and relatively inert. When a propane medium is used, the process should be operated above the reaction diluent critical temperature and pressure. Preferably, a hexane or an isobutane medium is employed.

### Polyolefin Products

The present disclosure also relates to polyolefin compositions, such as resins, produced by the catalyst compound represented by Formula (I) and the methods described herein.

In at least one embodiment, a process includes utilizing the catalyst compound represented by Formula (I) to produce propylene homopolymers or propylene copolymers, such as propylene-ethylene and/or propylene-alphaolefin (preferably C3 to C20) copolymers (such as propylene-hexene copolymers or propylene-octene copolymers) having an Mw/Mn of greater than about 1, such as greater than about 2, such as greater than about 3, such as great than about 4.

In at least one embodiment, a process includes utilizing the catalyst compound represented by Formula (I) to produce olefin polymers, preferably polyethylene and polypropylene homopolymers and copolymers. In at least one embodiment, the polymers produced herein are homopolymers of ethylene or copolymers of ethylene preferably having between about 0 and 25 mole % of one or more C3 to C20 olefin comonomer (such as between about 0.5 and 20 mole %, such as between about 1 and about 15 mole %, such as between about 3 and about 10 mole %). Olefin comonomers may be C3 to C12 alpha-olefins, such as one or more of propylene, butene, hexene, octene, decene, or dodecene, preferably propylene, butene, hexene, or octene. Olefin monomers may be one or more of ethylene or C4 to C12 alpha-olefin, preferably ethylene, butene, hexene, octene, decene, or dodecene, preferably ethylene, butene, hexene, or octene.

In a preferred embodiment, the monomer is ethylene and the comonomer is hexene, preferably between about 4 mol % hexene (comonomer content) and about 15 mol % hexene, such as between about 6 mol % hexene and about 10 mol % hexene, such as at least about 8 mol % hexene.

Polymers produced herein may have an Mw of between about 5,000 and about 1,000,000 g/mol (such as between about 25,000 and about 750,000 g/mol, such as between about 50,000 and about 500,000 g/mol), and/or an Mw/Mn of between about 1 and about 40 (such as between about 1.2 and about 20, such as between about 1.3 and about 10, such as between about 1.4 and about 5, such as between about 1.5 and about 4, such as between about 1.5 and about 3).

In a preferred embodiment the polymer produced herein has a multimodal molecular weight distribution as determined by Gel Permeation Chromatography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versa).

In a preferred embodiment, the polymer produced herein has a composition distribution breadth index (CDBI) of 50% or more, preferably 60% or more, preferably 70% or more. CDBI is a measure of the composition distribution of monomer within the polymer chains and is measured by the procedure described in PCT publication WO 93/03093, published Feb. 18, 1993, specifically columns 7 and 8 as well as in Wild et al., J. Poly. Sci., Poly. Phys. Ed., Vol. 20, p. 441 (1982) and U.S. Pat. No. 5,008,204, including those fractions having a weight average molecular weight (Mw) below 15,000 are ignored when determining CDBI.

In another embodiment, the polymer produced herein has two peaks in the TREF measurement. Two peaks in the TREF measurement as used in this specification and the appended claims means the presence of two distinct normalized ELS (evaporation mass light scattering) response peaks in a graph of normalized ELS response (vertical or y axis) versus elution temperature (horizontal or x axis with temperature increasing from left to right) using the TREF method below. A “peak” in this context means where the general slope of the graph changes from positive to negative with increasing temperature. Between the two peaks is a local minimum in which the general slope of the graph changes from negative to positive with increasing temperature. “General trend” of the graph is intended to exclude the multiple local minimums and maximums that can occur in intervals of 2° C. or less. Preferably, the two distinct peaks are at least 3° C. apart, more preferably at least 4° C. apart, even more preferably at least 5° C. apart. Additionally, both of the distinct peaks occur at a temperature on the graph above 20° C. and below 120° C. where the elution temperature is run to 0° C. or lower. This limitation avoids confusion with the apparent peak on the graph at low temperature caused by material that remains soluble at the lowest elution temperature. Two peaks on such a graph indicate a bi-modal composition distribution (CD). TREF analysis is done using a CRYSTAF-TREF 200+ instrument from Polymer Char, S.A., Valencia, Spain. The principles of TREF analysis and a general description of the particular apparatus to be used are given in the article Monrabal, B.; del Hierro, P. Anal. Bioanal. Chem. 2011, 399, 1557. An alternate method for TREF measurement can be used if the method above does not show two peaks, i.e., see B. Monrabal, “Crystallization Analysis Fractionation: A New Technique for the Analysis of Branching Distribution in Polyolefins,” Journal of Applied Polymer Science, Vol. 52, 491-499 (1994).

### Blends

In at least one embodiment, the polymer (such as polyethylene or polypropylene) produced herein is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In at least one embodiment, the polymer (such as polyethylene or polypropylene) is present in the above blends, at between about 10 and about 99 wt %, based upon the weight of total polymers in the blend, such as between about 20 and about 95 wt %, such as between about 30 and about 90 wt %, such as between about 40 and about 90 wt %, such as between about 50 and about 90 wt %, such as between about 60 and about 90 wt %, such as between about 70 and about 90 wt %.

Blends of the present disclosure may be produced by mixing the polymers of the present disclosure with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

Blends of the present disclosure may be formed using conventional equipment and methods, such as by dry blending the individual components, such as polymers, and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc; mixtures thereof, and the like.

In at least one embodiment, a polyolefin composition, such as a resin, that is a multi-modal polyolefin composition comprises a low molecular weight fraction and/or a high molecular weight fraction. In at least one embodiment, the high molecular weight fraction is produced by the catalyst compound represented by Formula (I). The low molecular weight fraction may be produced by a second catalyst compound that is a bridged or unbridged metallocene catalyst compound, as described above. The high molecular weight fraction may be polypropylene, polyethylene, and copolymers thereof. The low molecular weight fraction may be polypropylene, polyethylene, and copolymers thereof.

In at least one embodiment, the polyolefin composition produced by a catalyst system of the present disclosure has a comonomer content between about 3 wt % and about 15 wt %, such as between about 4 wt % and bout 10 wt %, such as between about 5 wt % and about 8 wt %. In at least one embodiment, the polyolefin composition produced by a catalyst system of the present disclosure has a polydispersity index of between about 2 and about 6, such as between about 2 and about 5.

### Films

Any of the foregoing polymers, such as the foregoing polyethylenes or blends thereof, may be used in a variety of end-use applications. Such applications include, for example, mono- or multi-layer blown, extruded, and/or shrink films. These films may be formed by any suitable extrusion or coextrusion techniques, such as a blown bubble film processing technique, where the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble process and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically the films are oriented in the Machine Direction (MD) at a ratio of up to 15, preferably between 5 and 7, and in the Transverse Direction (TD) at a ratio of up to 15, preferably 7 to 9. However, in another embodiment, the film is oriented to the same extent in both the MD and TD directions.

The films may vary in thickness depending on the intended application; however, films of a thickness from 1 to 50 μm may be suitable. Films intended for packaging are usually from 10 to 50 μm thick. The thickness of the sealing layer is typically 0.2 to 50 m. There may be a sealing layer on both the inner and outer surfaces of the film or the sealing layer may be present on only the inner or the outer surface.

In another embodiment, one or more layers may be modified by corona treatment, electron beam irradiation, gamma irradiation, flame treatment, or microwave. In a preferred embodiment, one or both of the surface layers is modified by corona treatment.

### EXAMPLES

The following abbreviations may be used below: (eq. means equivalents). Melt index (MI) also referred to as I₂, reported in dg/min, is determined according to ASTM D1238, 190° C., 2.16 kg load.

High load melt index (HLMI) also referred to as I₂₁, reported in dg/min, is determined according to ASTM D1238, 190° C., 21.6 kg load.

Melt index ratio (MIR) is MI divided by HLMI as determined by ASTM D1238.

All reagents were obtained from Sigma Aldrich (St. Louis, Mo.) and used as obtained, unless stated otherwise. All solvents were anhydrous. All reactions were performed under an inert nitrogen atmosphere, unless otherwise stated. All deuterated solvents were obtained from Cambridge Isotopes (Cambridge, Mass.) and dried over 3 Angstrom molecular sieves before use.

All molecular weights are weight average unless otherwise noted. All molecular weights are reported in g/mol unless otherwise noted.

Products were characterized as follows:

### ¹H NMR

Unless otherwise indicated, 1H NMR data was collected at room temperature in a 5 mm probe using a Bruker NMR spectrometer operating with a 1H frequency of 400 or 500 MHz. Data was recorded using a 30° flip angle RF pulse, 8 scans, with a delay of 5 seconds between pulses. Samples were prepared using approximately 5-10 mg of compound dissolved in approximately 1 mL of an appropriate deuterated solvent, as listed in the experimental examples. Samples are referenced to residual proton of the solvents at 7.15, 7.24, 5.32, 5.98, and 2.10 for D5-benzene, chloroform, D-dichloromethane, D-1,1,2,2-tetrachloroethane, and C₆D₅CD₂H, respectively. Unless stated otherwise, NMR spectroscopic data of polymers was recorded in a 5 or 10 mm probe on the spectrometer at 120° C. using a d₂-1,1,2,2-tetrachloroethane solution prepared from approximately 20 mg of polymer and 1 mL of solvent. Unless stated otherwise, data was recorded using a 30° flip angle RF pulse, 120 scans, with a delay of 5 seconds between pulses.

All reactions were performed in an inert N₂ purged glove box unless otherwise stated. All anhydrous solvents were purchased from Fisher Chemical and were degassed and dried over molecular sieves prior to use. Deuterated solvents were purchased from Cambridge Isotope Laboratories and dried over molecular sieves prior to use. n-Butyl lithium (2.5 M solution in hexane), methylmagnisium bromide (3.0 M solution in diethyl ether), dichloromethylsilane (Me(H)SiCl₂) and dichlorophenylsilane (Ph(H)SiCl₂) were purchased from Sigma-Aldrich, and hafnium tetrachloride (HfCl₄) 99+%, was purchased from Strem Chemicals and used as received. Lithium-n-propylcyclopentadienide was procured from Boulder Scientific.

### Gel Permeation Chromatography (4D GPC)

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol. Molecular weight distribution (“MWD”) is equivalent to the expression M_{w}/Mₙ. The expression M_{w}/Mₙ is the ratio of the weight average molecular weight (Mw) to the number average molecular weight (Mₙ).

The distribution and the moments of molecular weight (Mw, Mn, Mw/Mn, etc.), the comonomer content (C₂, C₃, C₆, etc.) and the long chain branching (g′) are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10 μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1 μm Teflon filter and degassed with an online degasser before entering the GPC instrument. The nominal flow rate is 1.0 mL/min and the nominal injection volume is 200 μL. The whole system including transfer lines, columns, detectors are contained in an oven maintained at 145° C. A given amount of polymer sample is weighed and sealed in a standard vial with 80 μL flow marker (Heptane) added to it. After loading the vial in the autosampler, polymer is automatically dissolved in the instrument with 8 mL added TCB solvent. The polymer is dissolved at 160° C. with continuous shaking for about 1 hour for most PE samples or 2 hour for PP samples. The TCB densities used in concentration calculation are 1.463 g/ml at room temperature and 1.284 g/ml at 145° C. The sample solution concentration is from 0.2 to 2.0 mg/ml, with lower concentrations being used for higher molecular weight samples.

The concentration (c), at each point in the chromatogram is calculated from the baseline-subtracted IR5 broadband signal intensity (I), using the following equation:

c=βI

where β is the mass constant determined with PE or PP standards. The mass recovery is calculated from the ratio of the integrated area of the concentration chromatography over elution volume and the injection mass which is equal to the pre-determined concentration multiplied by injection loop volume.

The conventional molecular weight (IR MW) is determined by combining universal calibration relationship with the column calibration which is performed with a series of monodispersed polystyrene (PS) standards ranging from 700 to 10M. The MW at each elution volume is calculated with following equation.

$$log M = \frac{log ( {K}_{PS} / K )}{a + 1} + \frac{{a}_{PS} + 1}{a + 1} log {M}_{PS}$$

where the variables with subscript “PS” stands for polystyrene while those without a subscript are for the test samples. In this method, a_{PS}=0.67 and K_{PS}=0.000175 while a and K are calculated from a series of empirical formula established in ExxonMobil and published in literature (T. Sun, P. Brant, R. R. Chance, and W. W. Graessley, Macromolecules, Volume 34, Number 19, pp. 6812-6820, (2001)). Specifically, a/K=0.695/0.000579 for PE and 0.705/0.0002288 for PP.

The comonomer composition is determined by the ratio of the IR5 detector intensity corresponding to CH₂ and CH₃ channel calibrated with a series of PE and PP homo/copolymer standards whose nominal value are predetermined by NMR or FTIR such as EMCC commercial grades about LLDPE.

The LS detector is the 18-angle Wyatt Technology High Temperature DAWN HELEOSII. The LS molecular weight (AM) at each point in the chromatogram is determined by analyzing the LS output using the Zimm model for static light scattering (M. B. Huglin, LIGHT SCATTERING FROM POLYMER SOLUTIONS, Academic Press, 1971):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient. P(θ) is the form factor for a monodisperse random coil, and Kₒ is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, is, for the solution flowing through the viscometer is calculated from their outputs. The intrinsic viscosity, [1], at each point in the chromatogram is calculated from the following equation:

[η]=ηₛ/c

where c is concentration and was determined from the IR5 broadband channel output. The viscosity MW at each point is calculated from the below equation:

M=K_{PS}M^{α}^{_{PS}}⁺¹/[η].

The branching index (g′ᵥᵢₛ) is calculated using the output of the GPC-DRI-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits.

The branching index g′ᵥᵢₛ is defined as:

$$g ' vis = \frac{{[ η ]}_{avg}}{{kM}_{v}^{α}}$$

My is the viscosity-average molecular weight based on molecular weights determined by LS analysis. Z average branching index (g′_{Zave}) is calculated using Ci=polymer concentration in the slice i in the polymer peak times the mass of the slice squared, Mi².

All molecular weights are weight average unless otherwise noted. All molecular weights are reported in g/mol unless otherwise noted.

Comonomer Composition Determination with PolymerChar GPC-IR

The comonomer composition is determined by the ratio of the IR detector intensity corresponding to CH₂ and CH₃ channel calibrated with a series of PE and PP homo/copolymer standards whose nominal value are predetermined by NMR or FTIR.

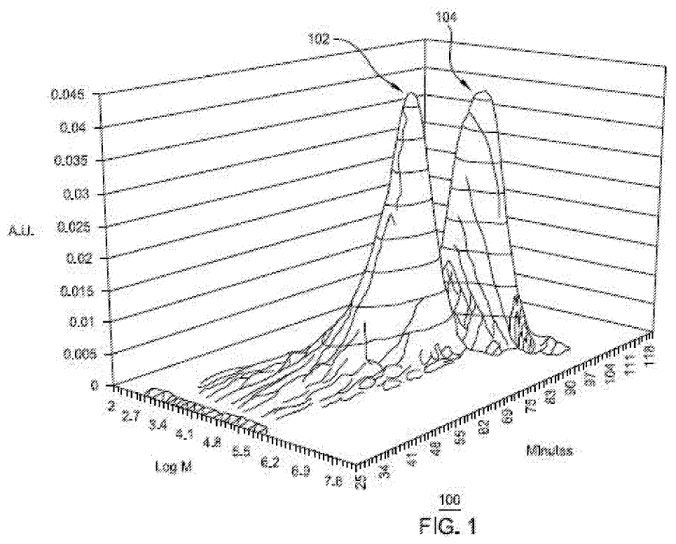

CFC was performed according to the following procedure: Cross-fractionation chromatography (CFC) analysis was done using a CFC-2 instrument from Polymer Char, S.A., Valencia, Spain. The principles of CFC analysis and a general description of the particular apparatus used are given in the article Ortin, A.; Monrabal, B.; Sancho-Tello, J. Macromol. Symp. 2007, 257, 13. FIG. 1 of the article is an appropriate schematic of the particular apparatus used. Pertinent details of the analysis method and features of the apparatus used are as follows.

1,2-Dichlorobenzene (ODCB) solvent stabilized with approximately 380 ppm of 2,6-bis(1,1-dimethylethyl)-4-methylphenol (butylated hydroxytoluene) was used for preparing the sample solution and for elution. The sample to be analyzed (approximately 50 mg) was dissolved in ODCB (25 ml metered at ambient temperature) by stirring (200 rpm) at 150° C. for 75 min. A small volume (0.5 ml) of the solution was introduced into a TREF column (stainless steel; o.d., ⅜″; length, 15 cm; packing, non-porous stainless steel micro-balls) at 150° C., and the column temperature was stabilized for 30 min at a temperature (120-125° C.) approximately 20° C. higher than the highest-temperature fraction for which the GPC analysis was included in obtaining the final bivariate distribution. The sample volume was then allowed to crystallize in the column by reducing the temperature to 30° C. at a cooling rate of 0.2° C./min. The low temperature was held for 10 min before injecting the solvent flow (1 ml/min) into the TREF column to elute the soluble fraction (SF) into the GPC columns (3× PLgel 10 μm Mixed-B 300×7.5 mm, Varian, Inc.); the GPC oven was held at high temperature (140° C.). The SF was eluted for 5 min from the TREF column and then the injection valve was put in the “load” position for 40 min to completely elute all of the SF through the GPC columns (standard GPC injections). All subsequent higher-temperature fractions were analyzed using overlapped GPC injections wherein at each temperature step the polymer was allowed to dissolve for at least 16 min and then injected from the TREF column into the GPC column for 3 min. The IR4 (Polymer Char) infrared detector was used to generate an absorbance signal that is proportional to the concentration of polymer in the eluting flow.

The universal calibration method was used for determining the molecular weight distribution (MWD) and molecular-weight averages (Mn, Mw, etc.) of eluting polymer fractions. Thirteen narrow molecular-weight distribution polystyrene standards (obtained from Polymer Labs, UK) within the range of 1.5-8200 kg/mol were used to generate a universal calibration curve. Mark-Houwink parameters were obtained from Appendix I of Mori, S.; Barth, H. G. Size Exclusion Chromatography; Springer, 1999. For polystyrene K=1.38×10-4 dl/g and α=0.7; and for polyethylene K=5.05×10-4 dl/g and α=0.693 were used. For a polymer fraction, which eluted at a temperature step, that has a weight fraction (weight % recovery) of less than 0.5%, the MWD and the molecular-weight averages were not computed; additionally, such polymer fractions were not included in computing the MWD and the molecular-weight averages of aggregates of fractions.

All manipulations were performed in an inert N₂ purged glove box unless otherwise stated. All anhydrous solvents were purchased from Fisher Chemical and were degassed and dried over molecular sieves prior to use. Toluene for the catalyst preparation was pre-dried with Al₂O₃ beads then dried over SMAO 757 before use. Deuterated solvents were purchased from Cambridge Isotope Laboratories and dried over molecular sieves prior to use. n-Butyl lithium (2.5 M solution in hexane), indene, methylmagnisium bromide (3.0 M solution in diethyl ether), dimethylsilyl dichloride (Me₂SiCl₂), diphenylsilyl dichloride (Ph₂SiCl₂) and silver trifluoromethanesulfonate (AgOTf) were purchased from Sigma-Aldrich, and hafnium tetrachloride (HfCl₄) 99+%, and zirconium tetrachloride (ZrCl₄) 99+% were purchased from Strem Chemicals and used as received. Lithium-n-propylcyclopentadienide was procured from Boulder Scientific. 1-Methylindene and lithium-1-methylindene were prepared according to the literature methods. (Amsharov, K., et al., Angew. Chem. Int. Ed. (2010), 49, 9392-9396). The ¹H NMR measurements were recorded on a 400 MHz Bruker spectrometer. (Cp)IndZrCl₂ was prepared according to the method disclosed in WO 98/28350.

Synthesis of Dimethylsilyl-bis(n-propylcyclopentadiene), Me₂Si(n-Pr-CpH)₂: In a 500 mL round bottom flask, a neat Me₂SiCl₂ (18.1 g, 140 mmol) was dissolved in 400 mL of THF and cooled to −25° C., and this was added to a solid lithium-n-propylcyclopentadienide (32.0 g, 280 mmol) over a period of 10-15 minutes. The resulting reddish mixture was stirred overnight at room temperature to ensure completion of the reaction. All volatiles from the reaction mixture were removed in vacuo, and further triturated with hexane. The crude materials were then extracted with hexane (50 mL×4) and followed by solvent removal afforded a thick red oil of Me₂Si(n-Pr-CpH)₂ in 38.0 g (99.6%) yield.

Synthesis of Lithium dimethylsilyl-bis(n-propylcyclopentadiene), Me₂Si(n-Pr-Cp)₂Li₂: In a 500 mL round bottom flask, a neat Me₂Si(n-Pr-CpH)₂ (38.0 g, 140 mmol) was dissolved in 400 mL of THF and cooled to −25° C., and this was added to a hexane solution of n-butyl lithium (112.7 mL, 282 mmol, 2.02 equivalents) over a period of 45-60 minutes. The resulting mixture was gradually warmed to room temperature and continuously stirred overnight. All volatiles from the reaction mixture were removed in vacuo, and triturated with hexane to evaporate trace of THF. The crude materials were thoroughly washed with hexane to remove any soluble impurities, and dried under vacuum to give an off-white solid of Me₂Si(n-Pr-Cp)₂Li₂ in 48.73 g (83.5%) yield.

Synthesis of Rac-meso-dimethylsilyl-bis(n-propylcyclopentadiene)hafnium dichloride, Me₂Si(n-Pr-Cp)₂HfCl₂: In a 1 L round bottom flask, a solid HfCl₄ (54.52 g, 170 mmol) was slurried in 800 mL of diethyl ether and cooled to −25° C., and this was added to a solid Me₂Si(n-Pr-Cp)₂Li₂ (48.73 g, 170 mmol) over a period of 15-20 minutes. The resulting mixture was stirred 48 hours at room temperature. Volatiles from the reaction mixture were removed in vacuo, and washed with cold hexane. The crude reddish materials were extracted with dichloromethane to remove the byproduct lithium chloride and other insoluble impurities. Solvent removal under reduced pressure afforded a thick red oil of Me₂Si(n-Pr-Cp)₂HfCl₂ in 60.6 g (60.2%) yield. The ¹H NMR spectrum of final material integrated a ˜1:1 ratio of rac/meso isomers.

Synthesis of Rac-meso-dimethylsilyl-bis(n-propylcyclopentadiene)hafnium dimethyl, Me₂Si(n-Pr-Cp)₂HfMe₂: In a 1 L round bottom flask, a neat Me₂Si(n-Pr-Cp)₂HfCl₂ (60.6 g, 102 mmol) was dissolved in 400 mL of diethyl ether and cooled to −25° C., and this was added to an ethereal solution of MeMgBr (68.2 mL, 205 mmol) over a period of 45-60 minutes. The resulting mixture was gradually brought to room temperature and continuously stirred overnight. Insoluble materials including the byproduct MgBrCl were removed by filtration through a pad of celite. Volatiles from the filtrate were removed under reduced pressure, and then extracted with hexane (100 mL×4). Solvent removal in vacuo afforded a thick reddish oil of Me₂Si(n-Pr-Cp)₂HfMe₂ in 47.2 g (96.6%) yield. The ¹H NMR spectrum of final material integrated a ˜1:1 ratio of rac/meso isomers.

Synthesis of Diphenylsilyl-bis(trifluoromethanesulfonate), Ph₂Si(OTf)₂: In a 500 mL round bottom flask, a neat Ph₂SiCl₂ (20.0 g, 79.0 mmol) was dissolved in 250 mL of DCM and cooled to −25° C., and this was added to a solid silver trifluoromethanesulfonate (40.59 g, 158 mmol) over a period of 5-10 minutes. The resulting mixture was covered with aluminum foil and stirred overnight at room temperature. Insoluble byproduct AgCl was filtered out and volatiles from the filtrate were removed in vacuo to afford a colorless crystalline solid of Ph₂Si(OTf)₂ in 36.66 g (94.6%) yield.

Synthesis of Diphenylsilyl-bis(n-propylcyclopentadiene), Ph₂Si(n-Pr-CpH)₂: In a 500 mL round bottom flask, a solid Ph₂Si(OTf)₂ (36.7 g, 75.0 mmol) was slurried in 350 mL of diethyl ether and cooled to −25° C., and this was added to a solid lithium-n-propylcyclopentadienide (17.1 g, 150.0 mmol) over a period of 10-15 minutes. The resulting yellowish mixture was stirred overnight at room temperature to ensure completion of the reaction. All volatiles from the reaction mixture were removed in vacuo. The crude materials were extracted with hexane (60 mL×5) and followed by solvent removal afforded a pale yellow oil of Ph₂Si(n-Pr-CpH)₂ in 30.2 g (98.6%) yield.

Synthesis of Lithium diphenylsilyl-bis(n-propylcyclopentadiene), Ph₂Si(n-Pr-Cp)₂Li₂: In a 500 mL round bottom flask, a neat Ph₂Si(n-Pr-CpH)₂ (35.42 g, 140 mmol) was dissolved in 350 mL of THF and cooled to −25° C., and this was added to a hexane solution of n-butyl lithium (70.1 mL, 175.2 mmol, 2.02 equivalents) over a period of 45-60 minutes. The resulting mixture was gradually warmed to room temperature and continuously stirred overnight. All volatiles from the reaction mixture were removed in vacuo, and triturated with hexane to evaporate trace of THF. The crude materials were thoroughly washed with hexane to remove any soluble impurities, and dried under vacuum to give an off-white solid of Ph₂Si(n-Pr-Cp)₂Li₂ in 30.7 g (87%) yield.

Synthesis of Diphenylsilyl-bis(n-propylcyclopentadiene)hafnium dichloride, Ph₂Si(n-Pr-Cp)₂HfCl₂: In a 500 mL round bottom flask, a solid HfCl₄ (24.04 g, 75.2 mmol) was slurried in 400 mL of diethyl ether and cooled to −25° C., and this was added to a solid Ph₂Si(n-Pr-Cp)₂Li₂ (30.7 g, 75.2 mmol) over a period of 15-20 minutes. The resulting mixture was stirred overnight at room temperature. Insoluble materials were removed by filtration and subsequently volatiles from the filtrate were removed in vacuo. Again, the crude materials were first washed with cold hexane and then extracted with diethyl ether, followed by solvent removal afforded a pale yellow semi-solid of Ph₂Si(n-Pr-Cp)₂HfCl₂ in 16.54 g (34.2%) yield.

Synthesis of Rac-meso-diphenylsilyl-bis(n-propylcyclopentadiene)hafnium dimethyl, Ph₂Si(n-Pr-Cp)₂HfMe₂: In a 500 mL round bottom flask, a neat Ph₂Si(n-Pr-Cp)₂HfCl₂ (16.54 g, 25.7 mmol) was dissolved in 250 mL of diethyl ether and cooled to −25° C., and this was added to an ethereal solution of MeMgBr (17.3 mL, 51.9 mmol) over a period of 45-60 minutes. The resulting mixture was gradually warmed to room temperature and continuously stirred overnight. Insoluble materials were removed by filtration through a pad of celite. Volatiles from the filtrate were removed under reduced pressure, and then extracted with hexane (50 mL×4). Solvent removal in vacuo afforded a pale yellow oil of Ph₂Si(n-Pr-Cp)₂HfMe₂ in 12.2 g (78.7%) yield. The ¹H NMR spectrum of final material integrated a ˜1:1 ratio of rac/meso isomers.

### Fluorenyl-substituted Catalysts

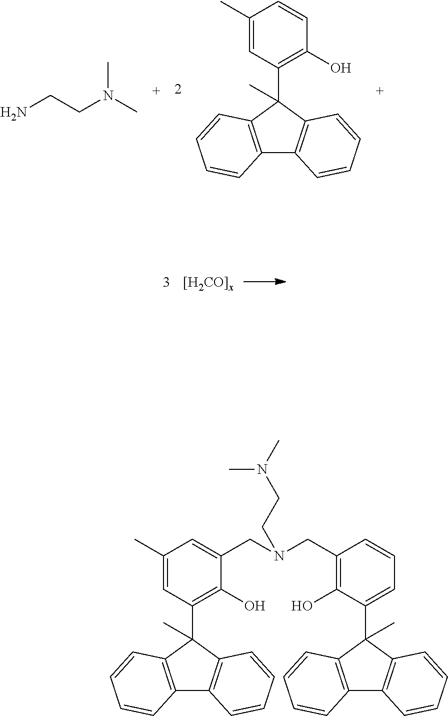

Synthesis of 2-(((2-(dimethylamino)ethyl)(2-hydroxy-3-(9-methyl-9H-fluoren-9-yl)benzyl)amino)methyl)-4-methyl-6-(9-methyl-9H-fluoren-9-yl)phenol. A 50 mL round-bottom flask was charged with 4-methyl-2-(9-methyl-9H-fluoren-9-yl)phenol (0.755 g, 2.64 mmol, 2 eq), paraformaldehyde (0.109 g, 3.63 mmol, 3 eq), LiCl (0.122 g, 2.88 mmol, 2 eq), 2-dimethylaminoethanamine (0.117 g, 1.33 mmol, 1 eq) and ethanol (4 mL). The resulting white slurry was stirred at 80° C. for 3 days then cooled to room temperature. The supernatant was decanted, and the crude product was purified over silica gel, eluting with a gradient of 0-20% ethyl acetate in hexane, to give the desired product (0.696 g, 77%) as a white powder.

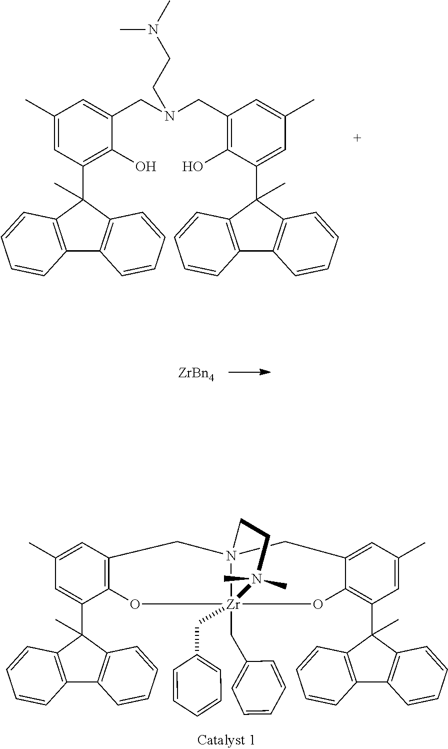

Synthesis of Catalyst 1: In a glovebox, a 20 mL vial was charged with 2-(((2-(dimethylamino)ethyl)(2-hydroxy-3-(9-methyl-9H-fluoren-9-yl)benzyl)amino)methyl)-4-methyl-6-(9-methyl-9H-fluoren-9-yl)phenol (0.1708 g, 0.2494 mmol, 1 eq), ZrBn₄ (0.1130 g, 0.2480 mmol, 1 eq), and 3 mL toluene. The resulting orange solution was stirred at 60° C. for 3 h then cooled to room temperature. The volatiles were removed from the mixture under nitrogen flow, and the resulting residue was recrystallized in 2 mL pentane at −35° C. Removal of the supernatant followed by drying under reduced pressure yielded Catalyst 1 (0.2304 g, 97%) as a pale yellow powder.

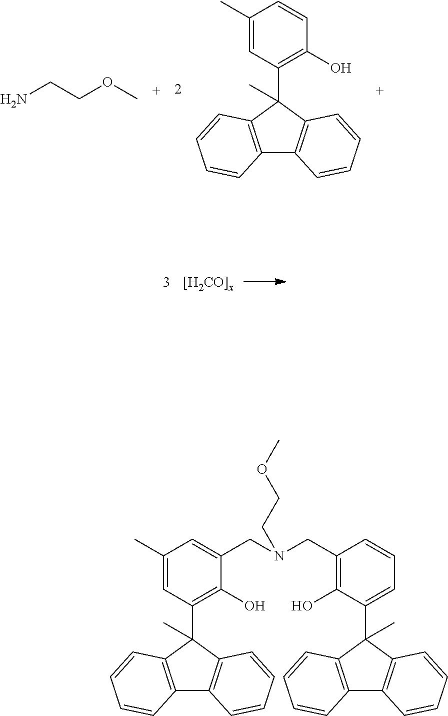

Synthesis of 2-(((2-hydroxy-3-(9-methyl-9H-fluoren-9-yl)benzyl)(2-methoxyethyl)amino)methyl)-4-methyl-6-(9-methyl-9H-fluoren-9-yl)phenol. A 50 mL round bottom flask was charged with S2 (0.696 g, 2.43 mmol, 2 eq), paraformaldehyde (0.116 g, 3.86 mmol, 3 eq), 2-methoxyethanamine (0.091 g, 1.21 mmol, 1 eq), 0.6 mL water and 3 mL methanol. The resulting white suspension was stirred at 80° C. overnight then cooled to room temperature. The supernatant was decanted, and the crude product was purified over a Biotage silica column using a gradient of 0-30% ethyl acetate in hexane, which yielded the desired product (0.262 g, 32%) as a white powder.

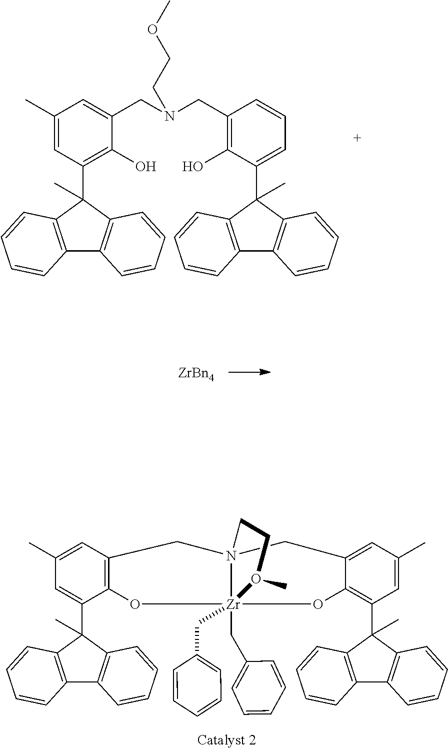

Synthesis of Catalyst 2: In a glovebox, a 20 mL vial was charged with L6 (0.262 g, 0.373 mmol, 1 eq), ZrBn₄ (0.1704 g, 0.3739 mmol, 1 eq), and 3 mL toluene. The resulting orange solution was stirred at 60° C. for 3 h then cooled to room temperature. The volatiles were removed from the mixture under nitrogen flow, and the resulting residue was recrystallized in 2 mL pentane at −35° C. Removal of the supernatant followed by drying under reduced pressure yielded Catalyst 2 (0.3566 g, quantitative) as a pale yellow powder.

TABLE 1
Silica Parameters

| | Calc. | | | | |
|---|---|---|---|---|---|
| | Temp | PS | SA | PD | PV |
| Silica | (° C.) | (μm) | (m²/g) | (Å) | (mL/g) |
| D948 | 600 | 58 | 278 | 242 | 1.68 |
| ES70 | 875 | 45 | 276 | 230 | 1.59 |
| PD14024 | 200 and | 85 | 611 | 92 | 1.40 |
| | 600 | | | | |
| PD13052 | 600 | 42 | 605 | 102 | 154 |

S-1 SMAO from D948 Silica Calcined at 600° C.

600° C. calcined 948 silica (40.7 g) was slurried in 200 mL of toluene. MAO (71.4 g of a 30 wt % toluene solution, 351.1 mmol of Al) was added slowly to the slurry. The slurry was then heated to 80° C. and stirred for 1 hour (hr). The slurry was filtered, washed three times with 70 mL of toluene and once with pentane. The solid was dried under vacuum overnight to give a 60.7 g amount of free flowing white solid “sMAO-D948-600”.

S-2 SMAO from ES70 Silica Calcined at 875° C.

In an 8 L stirred reactor, a 2000 gram amount of toluene and 1040 gram amount of MAO (30 wt % in toluene) were added and stirred for 5 minutes. Subsequently, a 800 gram amount ES-70 875C calcined silica was added by funnel to the stirred reactor, plus another 400 gram amount of toluene to rinse any remaining silica into the reactor. This slurry was stirred at 100° C. for 180 minutes. The reactor was then allowed to cool for 120 minutes to ambient temperature, then placed under vacuum for 72 hours while stirring slowly. The silica was unloaded and a 1079 gram amount of SMAO was obtained.

S-3 SMAO from (NH₄)₂SiF₆ Treated D948 Silica Calcined at 200° C.

2.41 g (NH₄)₂SiF₆ (13.5 mmol, 1.62 mmol F/g silica) was dissolved in 14.7 g water in a 20 ml glass vial. 50 g of Grace Davison D948™ silica and 200 g of toluene were combined in a 250 ml Wheaton CELSTIR™. Under vigorous stirring, the aqueous stock solution of (NH₄)₂SiF₆ was added via a syringe to the toluene slurry of silica. The mixture was allowed to stir at room temperature for 16 h. The slurry was filtered through a 250 ml Optichem™ disposable polyethylene frit, rinsed with 150 ml pentane for 2 times, then dried in air overnight to yield a white, free-flowing solid. The solid was transferred into a tube furnace, and was heated under constant nitrogen flow (temperature program: 25° C./h ramped to 150° C.; held at 150° C. for 4 hours; 50° C./h ramped to 200° C.; held at 200° C. for 4 hours; cooled down to room temperature). 47.2 g of fluorided silica-2 was collected after the calcination.

In a drybox, 10.6 g MAO toluene solution (Albermarle, 13.6 wt % Al) and 40 g of anhydrous toluene were combined in a 100 ml Wheaton CELSTIR™. The stirring rate was set to 450 rpm. 10.0 g of silica-2 was slowly added to the Celstir. The resulting slurry was allowed to stir at room temperature for 15 minutes. Then the Celstir was placed in a sand bath heated to 100° C. The slurry was heated at 100° C. for an additional 3 hours at a stirring rate of 250 rpm. The final slurry was filtered through a 110 ml Optichem disposable polyethylene frit. The solid collected in the frit was first rinsed with 40 g toluene for 3 times, then 40 g pentane for 3 times. The solid was dried in-vacuo for 16 hours. 12.9 g of sMAOsilica-2 was obtained.

S-4 Small Scale sMAO from PD14024

In the dry box, into a 150 mL Cel-Stir reactor were charged 10.05 g of 200° C. calcined PD14024 silica and 60 g of anhydrous toluene. The Cel-Stir reactor was placed in the freezer inside the drybox set at −35° C. for 1 hr. Placed the cold reactor on a stir plate and into the reactor was slowly added 26.43 g (13 mmol Al/g silica) 30% MAO solution (Albemarle product, 13.5 wt % Al or 5.0 mmol Al/g) stored in the same freezer. The cold mixture was then warmed up to ambient and stirred for another 15 min. Then the reactor was transferred to an oil-bath set at 100° C. and stirred for 3 hr. The reactor was allowed to cool to 40-50° C. and the slurry was filtered and washed with 1×120 g dry toluene and 2×120 g dry Hexane. The Wet Material was Dried Under Vacuum Overnight to Obtain 17.85 g sMAO.

S-5 Large Scale sMAO from PD14024

An Ace Glass 4 L jacketed filter reactor was set up in a N2 atmosphere dry box with a Lauda Proline RP 1845 temperature controller for cooling and heating. Raw materials: 200° C. calcined PD14024 silica 340 g, MAO 30% solution (Albemarle, Al=13.5% or 5.0 mmol Al/g) 864 g (based on 13 mmol Al/g silica), and toluene 2040 g. Procedure: Silica 340 g and toluene 2040 g were loaded into the reactor through a funnel. The agitator was turned on to 250 rpm and the cooling device was turned on to cool the slurry to −10 to −12° C. After reaching −10° C., the agitator was increased to 350 rpm. MAO solution 864 g was added slowly over a 2-3 hr period, with the slurry temperature maintained at <−8° C. After the MAO addition, the agitation was decreased to 250 rpm, and the slurry was allowed to agitate at −10° C. for 30 min, then the temperature was increased to 100° C. over 45-60 min. At 100° C., the slurry was allowed to agitate at 250 rpm for 3 hr. The slurry was cooled to 25° C. over a 30-45 min period. The agitator was stopped, contents filtered and the wet material was dried under vacuum for 3 hr then the wet solids were transferred to a container. Sampled: 1.00 g sample was dried with a vacuum drying system to constant weight to obtain 0.833 g dry solid weight, indicating 16.7 wt % toluene in the wet solid.

S-6 sMAO from PD15032

In the dry box, into a 150 mL Cel-Stir reactor were charged 5.0 g of 600° C. calcined PD15032 silica and 40 g of anhydrous toluene. The Cel-Stir reactor was placed in the freezer inside the drybox set at −35° C. for 1 hr. Placed the cold reactor on a stir plate and into the reactor was slowly added 11.3 g (11.3 mmol Al/g silica) 30% MAO solution (Albemarle product, 13.5 wt % Al or 5.0 mmol Al/g) stored in the same freezer. The cold mixture was then warmed up to ambient and stirred for another 15 min. Then the reactor was transferred to an oil-bath set at 100° C. and stirred for 3 hr. The reactor was allowed to cool to 40-50° C. and the slurry was filtered and washed with 1×80 g dry toluene and 2×80 g dry isohexane. The wet material was dried under vacuum overnight to obtain 8.34 g sMAO.

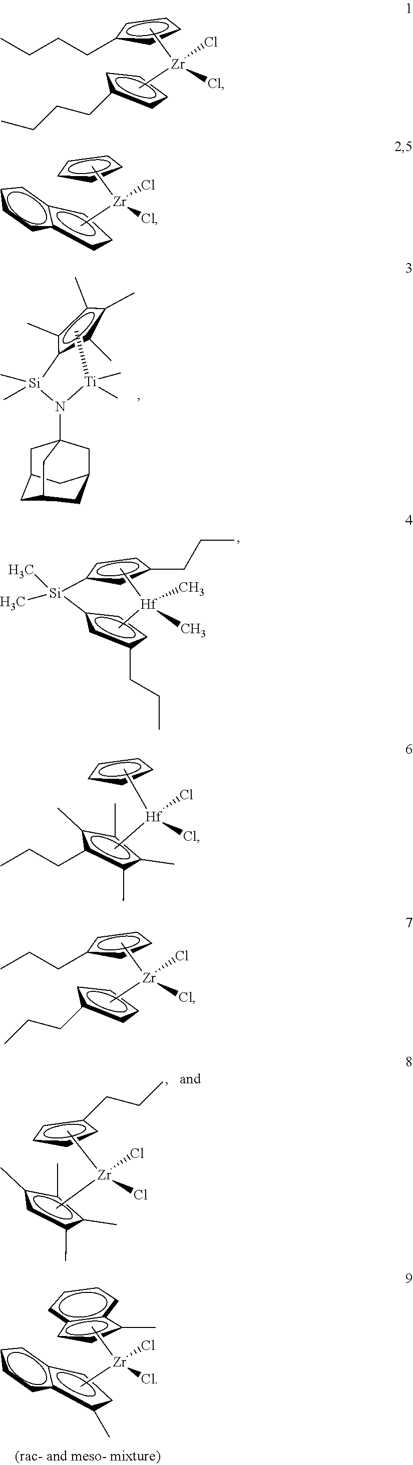

### Supported Catalysts:

### C-1 Supported Catalyst System 1:

(nBuCp)₂ZrCl₂ (0.0135 g, 0.0289 μmol) and Catalyst 1 (0.0276 g, 0.0289 μmol) were dissolved in 10 milliliters (ml) of toluene and added to a Celstir™ containing SMAO-D948-600 (S-1), a 1.45 gram amount in 15 ml of toluene. The slurry was stirred at room temperature for 1 hour. The solid was filtered, washed three times with 20 ml of toluene, and washed twice with pentane. The solid was dried under vacuum to give a 1.24 gram amount of off-white powder.

### C-2 Supported Catalyst System 2: CpIndZrCl₂:2332 27117-085, 27086-80 Prep

A 1.0 g amount of prepared ES-70 875C SMAO (S-2) was stirred in 10 mL of toluene using a Celstir™ flask. (Cyclopentadienyl)(indenyl) zirconium dichloride (6.8 mg, μmol) and 2-dimethylamino-N,N-bis[methylene(4-methyl-2-(9-methyl-9H-fluoren-9-yl)phenolate)]ethanamine zirconium(IV) dibenzyl (Catalyst 1) (19.1 mg, 20 μmol) were added to the slurry and stirred for three hours. The mixture was filtered, washed with several 10 mL portions of hexane and then dried under vacuum, yielding 0.92 g of light yellow silica.

### C-3 Supported Catalyst System 3:

A 1.0 g amount of prepared ES-70 875C SMAO (S-2) was stirred in 10 mL of toluene using a Celstir™ flask. Dimethylsilylene(tetramethylcyclopentadienyl)(2-adamantylamido) titanium(IV) dimethyl (13.2 mg, 33 μmol) and 2-dimethylamino-N,N-bis[methylene(4-methyl-2-(9-methyl-9H-fluoren-9-yl)phenolate)]ethanamine zirconium(IV) dibenzyl (Catalyst 1) (6.4 mg, 6.7 μmol) were added to the slurry and stirred for three hours. The mixture was filtered, washed with several 10 mL portions of hexane and then dried under vacuum, yielding 0.87 g of light yellow silica.

### C-4 Supported Catalyst System 4:

A 1.0 g amount of ES70 875 SMAO (S-2) (27005-36) was slurried in approximately 10 mL of toluene using a Celstir™ vessel. A 11.2 mg (30 μmol) amount of Rac-meso-dimethylsilyl-bis(n-propylcyclopentadienyl)hafnium dimethyl and a 9.6 mg (10 mol) amount of Catalyst 1 were added to the Celstir™ vessel from a stock solutions (1 mg/g toluene) of each catalyst. This mixture was stirred for three hours, after which the mixture was filtered using a glass frit. It was washed with two 10 mL portions of hexane and then dried under vacuum overnight. A 0.95 gram amount of light yellow silica was obtained.

### C-5 Supported Catalyst System 5:

A 1.0 gram amount of ES70 875 SMAO (S-2) (27005-36) was slurried in approximately 10 mL of toluene using a Celstir™ vessel. Next, 10.3 mg (30 μmol) of CpIndZrCl2 and 9.6 mg (10 μmol) of Catalyst 1 were added to the Celstir™ vessel from stock solutions (1 mg/g toluene) of each catalyst. This mixture was stirred for three hours, after which the mixture was filtered using a glass frit. It was washed with two 10 mL portions of hexane and then dried under vacuum overnight. A 0.93 gram amount of light yellow silica was obtained.

### C-6 Supported Catalyst System 6:

A 1.0 gram amount of ES70 875 SMAO (S-2) (27005-36) was slurried in approximately 10 mL of toluene using a Celstir™ vessel. A 14.3 mg (30 μmol) amount of Cp(1-n-propyl, 2,3,4,5-methylCp)HfCl₂ and 9.6 mg (10 μmol) amount of Catalyst 1 were added to the Celstir™ vessel from a stock solutions (1 mg/g toluene) of each catalyst. This mixture was stirred for three hours, after which the mixture was filtered using a glass frit. It was washed with two 10 mL portions of hexane and then dried under vacuum for three hours. A 0.95 gram amount of light yellow silica was obtained.

### C-7 Supported Catalyst System 7: HfP: 2332 27082-082, 27086-32 Prep

A 1.0 g amount of prepared ES-70 875C SMAO (S-2) was stirred in 10 mL of toluene using a Celstir™ flask. Bis(n-propylcyclopentadiene)hafnium(IV) dimethyl (8.4 mg, 20 μmol) and 2-dimethylamino-N,N-bis[methylene(4-methyl-2-(9-methyl-9H-fluoren-9-yl)phenolate)]ethanamine zirconium(IV) dibenzyl (Catalyst 1) (19 mg, 20 μmol) were added to the slurry and stirred for three hours. The mixture was filtered, washed with several 10 mL portions of hexane and then dried under vacuum, yielding 0.92 g of yellow silica.

### C-8 Supported Catalyst System 8

C-8-1 Catalyst 2: Metallocene 8=50:50 μMol/g sMAO on PD14024

A 1.0 g of silica supported MAO from S-4 was placed in a 20 mL vial with 6 g toluene. Catalyst 2 (49.0 mg, 50 μmol) and (n-propylcyclopentadiene)(2,3,4,5-methylcyclopentadiene)ZrCl₂ (16.5 mg, 50 μmol) were added to the slurry and placed on a shaker to shake for 1 hr. The mixture was filtered, washed with 1×10 mL toluene and 2×10 mL hexane and then dried under vacuum to constant weight, yielding 1.0 g of supported catalyst.

C-8-2 Catalyst 2: Metallocene 8=30:30 μMol/g sMAO on PD14024

A 1.2 g of silica supported MAO from S-5 (wet, containing sMAO 1.0 g and toluene 0.2 g) was placed in a 20 mL vial with 6 g toluene. Catalyst 2 (30.0 mg, 30 μmol) and (n-propylcyclopentadiene)(2,3,4,5-methylcyclopentadiene)ZrCl₂ (13.0 mg, 30 μmol) were added to the slurry and placed on a shaker to shake for 1 hr. The mixture was filtered, washed with 1×10 mL toluene and 2×10 mL hexane and then dried under vacuum to constant weight, yielding 1.0 g of supported catalyst.

### C-9 Supported Catalyst System 9

Catalyst 2: Metallocene 9=30:30 μMol/g sMAO on PD14024

A 1.2 g of silica supported MAO from S-5 (wet, containing sMAO 1.0 g and toluene 0.2 g) was placed in a 20 mL vial with 6 g toluene. Catalyst 2 (30.0 mg, 30 μmol) and rac/meso-bis(1-methylindenyl)ZrCl₂ (13.8 mg, 30 μmol) were added to the slurry and placed on a shaker to shake for 1 hr. The mixture was filtered, washed with 1×10 mL toluene and 2×10 mL hexane and then dried under vacuum to constant weight, yielding 0.99 g of supported catalyst.

### C-10 Supported Catalyst System 10

Catalyst 2: Metallocene 8=30:30 μMol/g sMAO on PD15032

A 1.0 g of silica supported MAO from S-6 was placed in a 20 mL vial with 6 g toluene. Catalyst 2 (30.5 mg, 30 mol) and (n-propylcyclopentadiene)(2,3,4,5-methylcyclopentadiene)ZrCl₂ (12.4 mg, 30 μmol) were added to the slurry and placed on a shaker to shake for 1 hr. The mixture was filtered, washed with 1×10 mL toluene and 2×10 mL hexane and then dried under vacuum to constant weight, yielding 1.0 g of supported catalyst.

Catalyst Activity During Polymerization with Organosilica Support Catalyst Systems

A 2 L autoclave was heated to 110° C. and purged with N₂ at least 30 minutes. It was charged with dry NaCl (350 g; Fisher, S271-10 dehydrated at 180° C. and subjected to several pump/purge cycles and finally passed through a 16 mesh screen prior to use) and SMAO (5 g) at 105° C. and stirred for 30 minutes. The temperature was adjusted to 85° C. At a pressure of 2 psig N₂, dry, degassed 1-hexene (2.0 mL) was added to the reactor with a syringe then the reactor was charged with N₂ to a pressure of 20 psig. A mixture of H₂ and N₂ was flowed into reactor (200 SCCM; 10% H₂ in N₂) while stirring the bed.

Various solid catalysts indicated in Table 2 were injected into the reactor with ethylene at a pressure of 220 psig; ethylene flow was allowed over the course of the run to maintain constant pressure in the reactor. 1-hexene was fed into the reactor as a ratio to ethylene flow (0.1 g/g). Hydrogen was fed to the reactor as a ratio to ethylene flow (0.5 mg/g). The hydrogen and ethylene ratios were measured by on-line GC analysis. Polymerizations were halted after 1 hour by venting the reactor, cooling to room temperature then exposing to air. Salt was removed by washing with water two times. Polymer was isolated by filtration, briefly washed with acetone and dried in air for at least two days.

TABLE 2
Ethylene/Hexene Co-Polymerization and Polymer Properties

| Supported | H2 | | | | | | | | | |
|---|---|---|---|---|---|---|---|---|---|---|
| Catalyst | charge | Yield | Prod. | Mw | Mn | | MI | HLMI | | Hexene |
| System | (mls) | (g polyethylene) | (g/g cat) | (g/mol) | (g/mol) | PDI | (dg/min) | (dg/min) | MIR | (wt %) |
| C-1 | 120 | 131 | 8,532 | 122,288 | 26,290 | 4.65 | 1.64 | 66.5 | 40.7 | 5.44 |
| C-1 | 120 | 102 | 7,634 | 109,287 | 31,847 | 3.43 | 1.06 | 31.8 | 30.1 | 8.74 |
| C-2 | 120 | 201 | 17,788 | 128,152 | 33,785 | 3.79 | 0.46 | 14.3 | 30.6 | 5.82 |
| C-3 | 600 | 62.6 | 3,084 | 120,256 | 28,702 | 4.19 | 1.4 | 45.5 | 32.5 | 5.7 |
| C-4 | 300 | 73.5 | 4,482 | 187,546 | 47,859 | 3.92 | .485 | 12.44 | 25.65 | 4.6 |
| C-5 | 120 | 77.1 | 10,145 | 92,002 | 42,348 | 2.17 | 2.44 | 47.04 | 19.28 | 8.5 |
| C-6 | 150 | 116.7 | 7,578 | 223,186 | 44,482 | 5.02 | .115 | 4.5 | 39.13 | 7.3 |
| C-7 | 120 | 78.3 | 5,291 | 251,838 | 59,384 | 4.24 | 0.07 | 1.61 | 22.59 | 5.26 |
| C8-1 | 120 | 74.1 | 5,614 | — | — | — | — | — | — | — |
| C8-1 | 150 | 110.1 | 7,473 | — | — | — | — | — | — | — |
| C8-2 | 0 | 194.9 | 13,441 | — | — | — | — | — | — | — |
| C8-2 | 70 | 56.4 | 10,642 | 189,251 | 64,577 | 2.93 | — | — | — | 4.67 |
| C8-2 | 100 | 31.0 | 7,381 | 156,932 | 51,026 | 3.08 | — | — | — | 4.72 |
| C8-2 | 450 | 99.9 | 6,167 | — | — | — | — | — | — | — |
| C9 | 0 | 34.0 | 3,148 | 272,100 | 57,360 | 4.74 | — | — | — | 4.82 |
| C9 | 80 | 103.8 | 7,362 | — | — | — | — | — | — | — |
| C9 | 150 | 77.3 | 7,578 | — | — | — | — | — | — | — |
| C10 | 0 | 124.7 | 8,844 | 304,394 | 100,153 | 3.04 | — | — | — | — |

Table 2 illustrates controlled polyethylene composition formation using catalyst systems comprising Catalyst 1 or Catalyst 2 and a variety of second catalysts, for example bridged or unbridged metallocenes. PDI values are between about 2 and about 5. Furthermore, hexene wt % values are between about 4 wt % and about 9 wt %. A catalyst compound represented by Formula (I) such as Catalyst 1 or Catalyst 2 can incorporate comonomer during polymerization of a polyolefin up to a wt % limit where hexene incorporation substantially ceases. Nonetheless, comonomer incorporation by the second catalyst can proceed uninterrupted or is even increased (positive cooperativity), highlighting the compatibility of a catalyst compound represented by Formula (I), such as Catalyst 1 or Catalyst 2, with a second catalyst of a catalyst system.

Furthermore, the controllable comonomer incorporation of a catalyst compound represented by Formula (I) having a fluorenyl moiety(s) can be compared to catalyst compounds of Formula (I) having a carbazole moiety(s) instead of a fluorenyl moiety(s). Without being bound by theory, it is believed that carbazole moieties have a flatter molecular geometry than fluorenyl moieties, which yields greater (and less controlled) comonomer incorporation during polymerization. Furthermore, catalyst compounds represented by Formula (I) having a fluorenyl moiety(s) provide higher molecular weight polyolefins than catalyst compounds of Formula (I) containing carbazole moieties.

FIG. 1 is a 4D GPC spectrum 100 of a polyethylene resin formed from Catalyst System 1. As shown in FIG. 1, a polyethylene resin formed from Catalyst System 1 is bimodal as shown by low molecular weight peak 102 and high molecular weight peak 104. Because of the compatibility of a catalyst compound represented by Formula (I) (such as Catalyst 1) with a metallocene catalyst of a catalyst system (nBuCp)₂ZrCl₂ of Catalyst System 1), the mole ratio of a catalyst compound represented by Formula (I) to metallocene catalyst can be readily varied. Varying the mole ratio of the two catalyst compounds provides controlled polyolefin composition formation and access to multimodal polyolefin compositions having desired physical properties. For example, the mole ratio of Catalyst 1 to nBuCp)₂ZrCl₂ of Catalyst System 1 is 1:1. An increase in Catalyst 1 content of the catalyst system to, for example, 2:1 provides more high molecular weight polyolefin content in the resulting polyolefin composition and provides easy control of physical properties of the polyolefin composition.

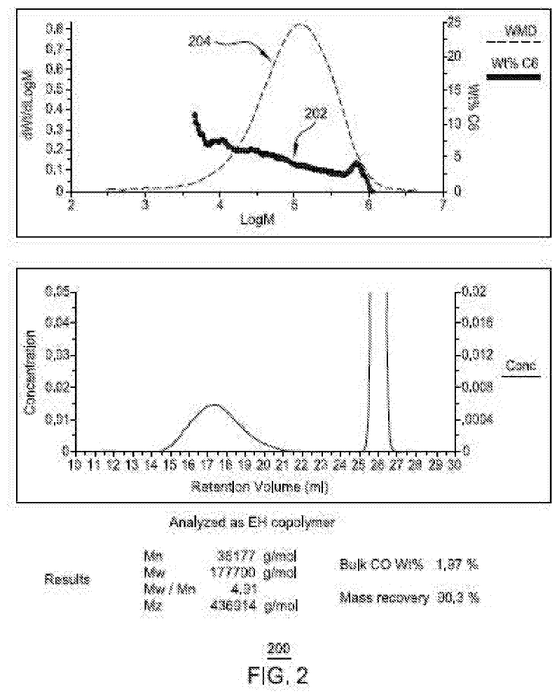

FIG. 2 is a GPC spectrum 200 of a polyethylene resin formed from Catalyst System 4. As shown in FIG. 2, comonomer content (line 202) ranges from about 5 wt % to about 4 wt %, with an average of 4.6 wt %. Line 202 has a negative slope illustrating Catalyst 1's ability to incorporate comonomer during polymerization of a polyolefin up to a wt % limit where hexene incorporation substantially ceases. MWD (line 204) for Catalyst System 4 is monodisperse.

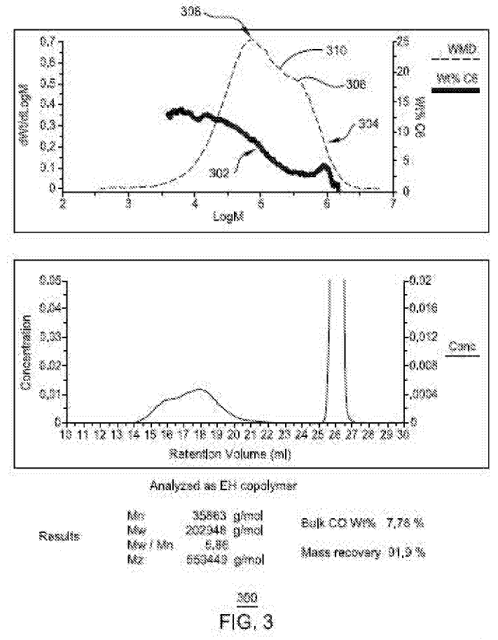

FIG. 3 is a GPC spectrum 300 of a polyethylene resin formed from Catalyst System 6. As shown in FIG. 3, comonomer content (line 302) ranges from about 3 wt % to about 4 wt %, with an average of 4.6 wt %. Like Catalyst System 4, line 302 has a negative slope. However, unlike Catalyst System 4, MWD (line 304) of polyolefin composition of Catalyst System 6 is multimodal as illustrated by peak 306, peak 308, and inflection point 310.

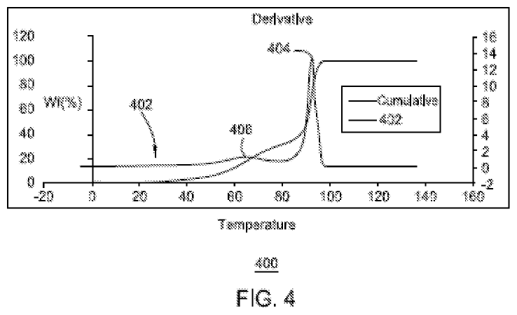

FIG. 4 is a TREF graph 400 for Supported Catalyst System 2. As shown in FIG. 4, Catalyst System 2 (line 402) provides a multimodal polyethylene copolymer having predominantly a high density copolymer (peak 404) with a lesser fraction of low density copolymer (peak 406). A low density copolymer fraction is between about 30 wt % and about 70 wt % of the polyolefin composition, and a high density copolymer fraction is between about 70 wt % and about 30 wt % of the polyolefin composition.

These data show that catalyst systems made of a catalyst compound represented by Formula (I) and a bridged or unbridged metallocene catalyst compound provide polyolefin compositions having a low molecular weight fraction and a high molecular weight fraction. Catalyst systems of the present disclosure provide novel polyolefin compositions with higher Mw capability as compared to typical metallocene mixed catalyst systems and are responsive to hydrogen for molecular weight control. Furthermore, a catalyst compound represented by Formula (I) does not interfere with (or even increases (positive cooperativity)) the polymerization catalysis of the bridged or unbridged metallocene catalyst compound (or vice versa), which provides fine tuning of, for example, Mw values of formed polyolefin compositions to yield novel polyolefin compositions.

A catalyst compound represented by Formula (I) is compatible with metallocene catalyst compounds under polymerization conditions, such that one catalyst of the catalyst system does not interfere with (or even increases (positive cooperativity)) the polymerization catalysis performed by the other catalyst of the catalyst system (or vice versa). The robust compatibility of a catalyst compound represented by Formula (I) provides catalyst systems and use of such catalyst systems where a second catalyst compound that can be a variety of metallocenes provides polyolefin compositions with variable PDI in the formed polyolefin compositions from high PDI to lower PDI with BCD compositions depending on the second catalyst compound.

All documents described herein are incorporated by reference herein, including any priority documents and/or testing procedures to the extent they are not inconsistent with this text. As is apparent from the foregoing general description and the specific embodiments, while some embodiments have been illustrated and described, various modifications can be made without departing from the spirit and scope of the disclosure. Accordingly, it is not intended that the disclosure be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

We claim:

1. A catalyst system comprising:
a first catalyst compound represented by Formula (I): 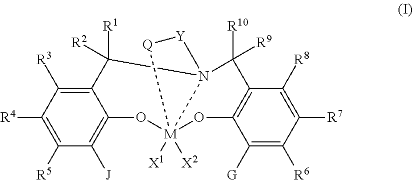
where M is a group 4 metal,
X¹ and X² are independently a univalent C1-C20 hydrocarbyl, C1-C20 substituted hydrocarbyl, a heteroatom or a heteroatom-containing group, or X¹ and X² join together to form a C4-C62 cyclic or polycyclic ring structure,
R¹, R², R³, R⁴, R⁵, R⁶, R⁷, R⁸, R⁹, and R¹⁰ is independently hydrogen, C1-C40 hydrocarbyl, C1-C40 substituted hydrocarbyl, a heteroatom or a heteroatom-containing group, or two or more of R¹, R², R³, R⁴, R⁵, R⁶, R⁷, R⁸, R⁹, or R¹⁰ are joined together to form a C4-C62 cyclic, heterocyclic or polycyclic ring structure, or a combination thereof,
Q is a neutral donor group,
J is heterocyclyl, a substituted or unsubstituted C7-C60 fused polycyclic group, where at least one ring is aromatic and where at least one ring, which may or may not be aromatic, has at least five ring atoms,
G is as defined for J or may be hydrogen, C2-C60 hydrocarbyl, C1-C60 substituted hydrocarbyl, or may independently form a C4-C60 cyclic or polycyclic ring structure with R⁶, R⁷, or R⁸ or a combination thereof, and
Y is divalent C1-C20 hydrocarbyl or divalent C1-C20 substituted hydrocarbyl or Q and Y together form a heterocycle; and
a second catalyst compound that is a bridged or unbridged metallocene.

2. The catalyst system of claim 1, wherein the first catalyst compound is represented by the Formula: 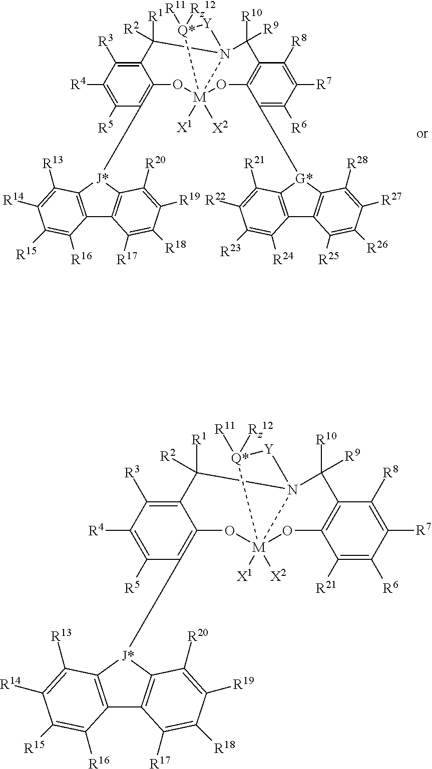
wherein:
M is Hf, Zr, or Ti,
X¹, X², R¹, R², R³, R⁴, R⁵, R⁶, R⁷, R⁸, R⁹, R¹⁰, and Y are as defined in claim 1,
R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, and R²⁸ is independently a hydrogen, C1-C40 hydrocarbyl, C1-C40 substituted hydrocarbyl, a functional group comprising elements from Groups 13 to 17, or two or more of R¹, R², R³, R⁴, R⁵, R⁶, R⁷, R⁸, R⁹, R¹⁰ R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, and R²⁸ may independently join together to form a C4-C62 cyclic or polycyclic ring structure, or a combination thereof, or R¹¹ and R¹² may independently join together to form a five- to eight-membered heterocycle,
Q* is a group 15 or 16 atom,
z is 0 or 1 with the proviso that z=0 if Q* is a group 16 atom and z=1 if Q* is a group 15 atom, J* is N or CR″, and G* is N or CR″, wherein R″ is C1-C20 hydrocarbyl or carbonyl-containing C1-C20 hydrocarbyl, and
Y is divalent C1-C20 hydrocarbyl or divalent C1-C20 substituted hydrocarbyl or Q and Y together form a heterocycle.

3. The catalyst system of claim 2, wherein the first catalyst compound is represented by the Formula: 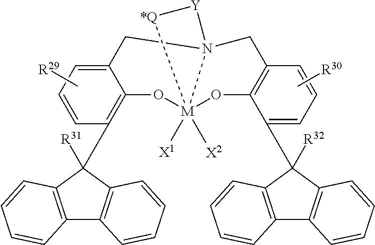
where Y is a divalent C1-C10 hydrocarbyl,
Q* is NR₂, OR, SR, PR₂, where R is as defined for R¹ in claim 1, or R and Y combine to form a C4-C62 cyclic or polycyclic ring structure,
M is Zr, Hf, or Ti,
X¹ and X² is independently as defined in claim 1,
R²⁹ and R³⁰ is independently C1-C40 hydrocarbyl, and
R³¹ and R³² is independently linear C1-C20 hydrocarbyl, benzyl, or tolyl.

4. The catalyst system of claim 1, wherein the first catalyst compound comprises one or more of:

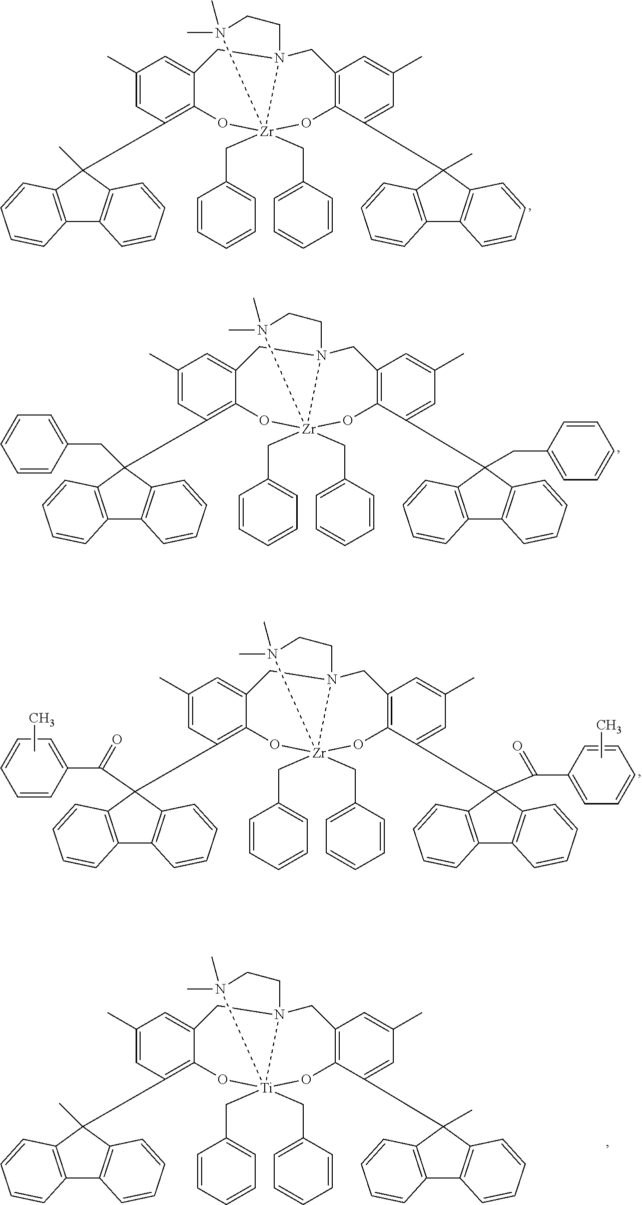

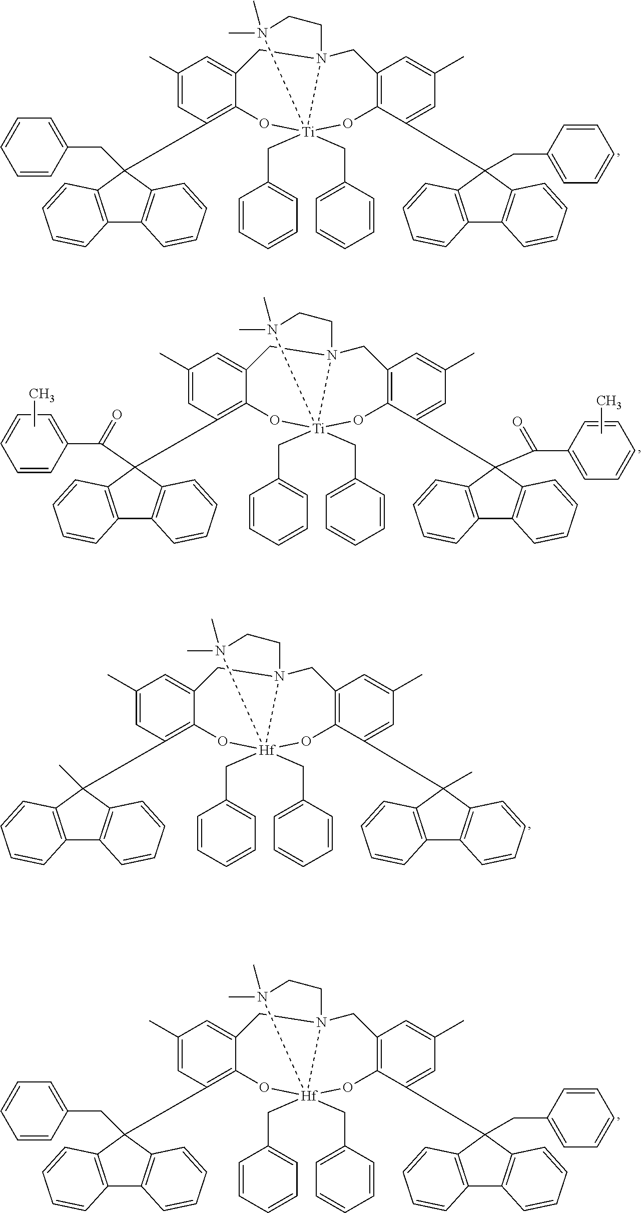

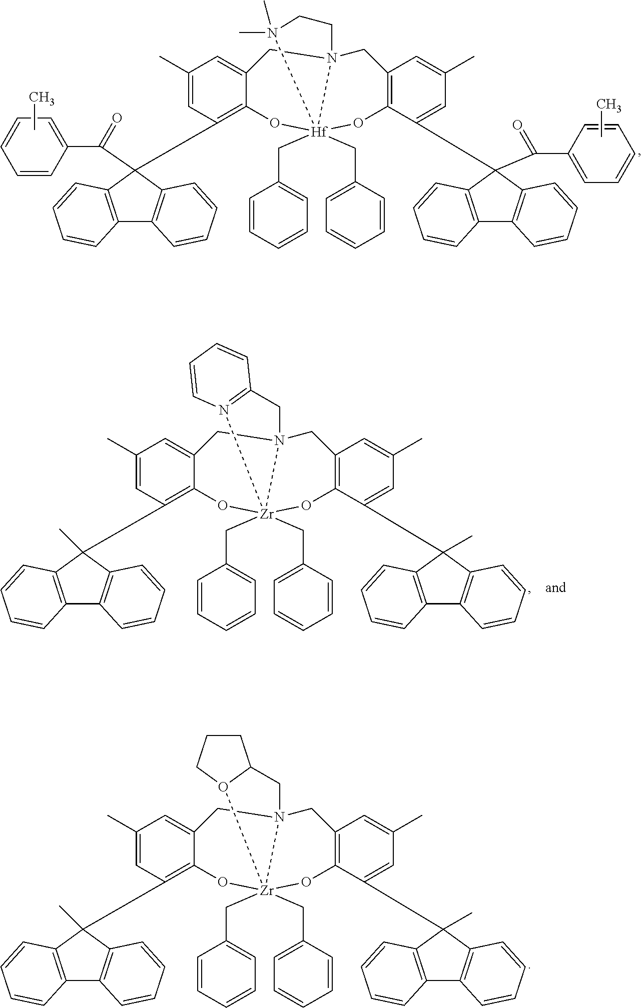

5. The catalyst system of claim 1, wherein the metallocene catalyst compound is an unbridged metallocene catalyst compound represented by the formula: Cp^{A}Cp^{B}M′X′ₙ, wherein each Cp^{A} and Cp^{B} is independently selected from the group consisting of cyclopentadienyl ligands and ligands isolobal to cyclopentadienyl, one or both Cp^{A} and Cp^{B} may contain heteroatoms, and one or both Cp^{A} and Cp^{B} may be substituted by one or more R″ groups, wherein M′ is selected from the group consisting of Groups 3 through 12 atoms and lanthanide Group atoms, wherein X′ is an anionic leaving group, wherein n is 0 or an integer from 1 to 4, wherein R″ is selected from the group consisting of alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, ether, and thioether.

6. The catalyst system of claim 5, wherein each Cp^{A} and Cp^{B} is independently selected from the group consisting of cyclopentadienyl, indenyl, fluorenyl, cyclopentaphenanthreneyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, and hydrogenated versions thereof.

7. The catalyst system of claim 1, wherein the metallocene catalyst compound is a bridged metallocene catalyst compound represented by the formula: Cp^{A}(A)Cp^{B}M′X′ₙ, wherein each Cp^{A} and Cp^{B} is independently selected from the group consisting of cyclopentadienyl ligands and ligands isolobal to cyclopentadienyl, one or both Cp^{A} and Cp^{B} may contain heteroatoms, and one or both Cp^{A} and Cp^{B} may be substituted by one or more R″ groups, wherein M′ is selected from the group consisting of Groups 3 through 12 atoms and lanthanide Group atoms, wherein X′ is an anionic leaving group, wherein n is 0 or an integer from 1 to 4, wherein (A) is selected from the group consisting of divalent alkyl, divalent lower alkyl, divalent substituted alkyl, divalent heteroalkyl, divalent alkenyl, divalent lower alkenyl, divalent substituted alkenyl, divalent heteroalkenyl, divalent alkynyl, divalent lower alkynyl, divalent substituted alkynyl, divalent heteroalkynyl, divalent alkoxy, divalent lower alkoxy, divalent aryloxy, divalent alkylthio, divalent lower alkylthio, divalent arylthio, divalent aryl, divalent substituted aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocycle, divalent heteroaryl, a divalent heteroatom-containing group, divalent hydrocarbyl, divalent lower hydrocarbyl, divalent substituted hydrocarbyl, divalent heterohydrocarbyl, divalent silyl, divalent boryl, divalent phosphino, divalent phosphine, divalent amino, divalent amine, divalent ether, divalent thioether; wherein R″ is selected from the group consisting of alkyl, lower alkyl, substituted alkyl, heteroalkyl, alkenyl, lower alkenyl, substituted alkenyl, heteroalkenyl, alkynyl, lower alkynyl, substituted alkynyl, heteroalkynyl, alkoxy, lower alkoxy, aryloxy, alkylthio, lower alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, lower hydrocarbyl, substituted hydrocarbyl, heterohydrocarbyl, silyl, boryl, phosphino, phosphine, amino, amine, ether, and thioether.

8. The catalyst system of claim 5, wherein each of Cp^{A} and Cp^{B} is independently selected from the group consisting of: cyclopentadienyl, n-propylcyclopentadienyl, indenyl, pentamethylcyclopentadienyl, tetramethylcyclopentadienyl, and n-butylcyclopentadienyl.

9. The catalyst system of claim 7, wherein (A) is O, S, NR′, or SiR′₂, wherein each R′ is independently hydrogen or C1-C20 hydrocarbyl.

10. The catalyst system of any of claim 1, wherein the metallocene catalyst compound is represented by the formula:
T_{y}CpₘMGₙX_{q}
wherein Cp is independently a substituted or unsubstituted cyclopentadienyl ligand or substituted or unsubstituted ligand isolobal to cyclopentadienyl, M is a group 4 transition metal, G is a heteroatom group represented by the formula JR*_{z} where J is N, P, O or S, and R* is a linear, branched, or cyclic C1-C20 hydrocarbyl and z is 1 or 2, T is a bridging group, and y is 0 or 1, X is a leaving group, and m=1, n=1, 2 or 3, q=0, 1, 2 or 3, and the sum of m+n+q is equal to the oxidation state of the transition metal.

11. The catalyst system of claim 10, wherein J is N, and R* is methyl, ethyl, propyl, butyl, pentyl, hexyl, heptyl, octyl, nonyl, cyclooctyl, cyclododecyl, decyl, undecyl, dodecyl, adamantyl or an isomer thereof.

12. The catalyst system of claim 1, wherein the metallocene catalyst compound is selected from the group consisting of:
dimethylsilyl (tetramethylcyclopentadienyl)(cyclododecylamido)titanium dimethyl;
dimethylsilyl (tetramethylcyclopentadienyl)(cyclododecylamido)titanium dichloride;
dimethylsilyl (tetramethylcyclopentadienyl)(t-butylamido)titanium dimethyl;
dimethylsilyl (tetramethylcyclopentadienyl)(t-butylamido)titanium dichloride;
μ-(CH₃)₂Si(cyclopentadienyl)(1-adamantylamido)M(R)₂;
μ-(CH₃)₂Si(3-tertbutylcyclopentadienyl)(1-adamantylamido)M(R)₂;
μ-(CH₃)₂(tetramethylcyclopentadienyl)(1-adamantylamido)M(R)₂;
μ-(CH₃)₂Si(tetramethylcyclopentadienyl)(1-adamantylamido)M(R)₂;
μ-(CH₃)₂C(tetramethylcyclopentadienyl)(1-adamantylamido)M(R)₂;
μ-(CH₃)₂Si(tetramethylcyclopentadienyl)(1-tertbutylamido)M(R)₂;
μ-(CH₃)₂Si(fluorenyl)(1-tertbutylamido)M(R)₂;
μ-(CH₃)₂Si(tetramethylcyclopentadienyl)(1-cyclododecylamido)M(R)₂;
μ-(C₆H₅)₂C(tetramethylcyclopentadienyl)(1-cyclododecylamido)M(R)₂; and
μ-(CH₃)₂Si(η⁵-2,6,6-trimethyl-1,5,6,7-tetrahydro-s-indacen-1-yl)(tertbutylamido)M(R)₂;
where M is selected from a group consisting of Ti, Zr, and Hf and R is selected from halogen or C1 to C5 alkyl.

13. The catalyst system of claim 1, wherein the metallocene catalyst compound comprises one or more of:

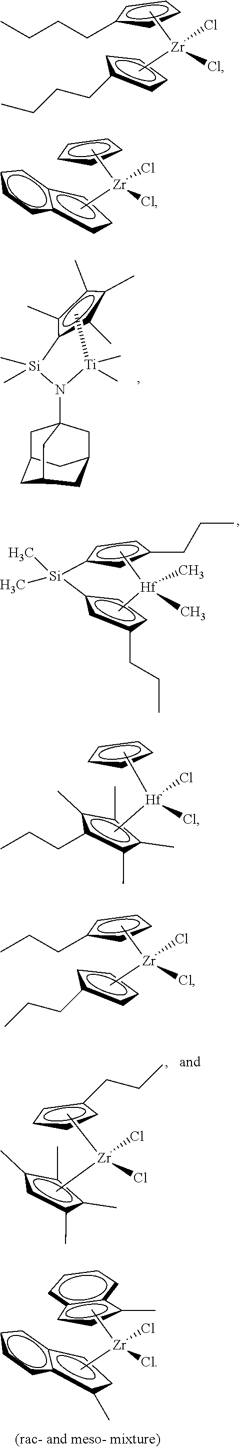

14. The catalyst system of claim 1, further comprising an activator and a support material.

15. The catalyst system of claim 14, wherein the activator comprises one or more of:
N,N-dimethylanilinium tetra(perfluorophenyl)borate,
N,N-dimethylanilinium tetrakis(perfluoronaphthyl)borate,
N,N-dimethylanilinium tetrakis(perfluorobiphenyl)borate,
N,N-dimethylanilinium tetrakis(3,5-bis(trifluoromethyl)phenyl)borate,
triphenylcarbenium tetrakis(perfluoronaphthyl)borate,
triphenylcarbenium tetrakis(perfluorobiphenyl)borate,
triphenylcarbenium tetrakis(3,5-bis(trifluoromethyl)phenyl)borate,
triphenylcarbenium tetra(perfluorophenyl)borate,
trimethylammonium tetrakis(perfluoronaphthyl)borate,
triethylammonium tetrakis(perfluoronaphthyl)borate,
tripropylammonium tetrakis(perfluoronaphthyl)borate,
tri(n-butyl)ammonium tetrakis(perfluoronaphthyl)borate,
tri(t-butyl)ammonium tetrakis(perfluoronaphthyl)borate,
N,N-diethylanilinium tetrakis(perfluoronaphthyl)borate,
N,N-dimethyl-(2,4,6-trimethylanilinium) tetrakis(perfluoronaphthyl)borate, and
tropillium tetrakis(perfluoronaphthyl)borate.

16. The catalyst system of claim 14, wherein the activator comprises an aluminum alkyl.

17. The catalyst system of claim 14, wherein the activator comprises an alkylalumoxane.

18. The catalyst system of claim 14, wherein the support material is selected from the group consisting of Al₂O₃, ZrO₂, SiO₂, or SiO₂/Al₂O₂.

19. The catalyst system of any of claim 14, wherein the support material is fluorided.

20. A method of polymerizing olefins to produce a polyolefin composition, the method comprising contacting at least one olefin with the catalyst system of any of claim 1 and obtaining a polyolefin.

21. The method of claim 20, wherein the polyolefin composition is a multi-modal polyolefin composition comprising ethylene and one or more comonomers and comprising a high molecular weight fraction having a comonomer content between about 5 wt % and about 10 wt % of the high molecular weight fraction.

22. The method of claim 19, wherein the polyolefin composition is a multi-modal polyolefin composition comprising a high molecular weight fraction having an Mw/Mn of between about 1 and about 5.

23. The method of claim 19, wherein alkylalumoxane is present at a molar ratio of aluminum to catalyst compound group 4 metal of 100:1 or more.

24. The method of claim 19, wherein the catalyst system further comprises an activator represented by the formula:
(Z)d+(Ad−)
wherein Z is (L-H) or a reducible Lewis Acid, L is an neutral Lewis base; H is hydrogen; (L-H)+ is a Bronsted acid; Ad− is a non-coordinating anion having the charge d−; and d is an integer from 1 to 3.

25. The method of claim 19, wherein the catalyst system further comprises an activator represented by the formula:
(Z)d+(Ad−)
wherein Ad− is a non-coordinating anion having the charge d−; d is an integer from 1 to 3, and Z is a reducible Lewis acid represented by the formula: (Ar₃C+), where Ar is aryl or aryl substituted with a heteroatom, a C1-C40 hydrocarbyl, or a substituted C1-C40 hydrocarbyl.
